(19) United States
(12) Patent Application Publication
(10) Pub. No.: US 2022/0267637 A1
(43) Pub. Date: Aug. 25, 2022

(54) MOULDABLE, FORMABLE AND CHEMICALLY RESISTANT HARD COAT FOR POLYMER FILM

(71) Applicant: Nanogate SE, Göttelborn (DE)

(72) Inventor: Cornelis Johannes Gerardus Maria van Peer, Halsteren (NL)

(73) Assignee: Nanogate SE, Göttelborn (DE)

(21) Appl. No.: 17/628,573

(22) PCT Filed: Jul. 23, 2020
(86) PCT No.: PCT/EP2020/070742

§ 371 Date: Jan. 20, 2022

(30) Foreign Application Priority Data
Jul. 25, 2019 (NL) 2023566

(51) Int. Cl. C09D 175/16

(52) U.S. Cl. CPC C09D 175/16

(57) ABSTRACT

The invention relates to a UV curable hard-coat for a polymer film, the hard-coat comprising an aliphatic urethane acrylate oligomer, a hexa-functional aliphatic urethane acrylate oligomer a photo-initiator and an organic solvent. The UV curable hard-coat further may comprise a flow modifier. A second aspect of the invention relates to a method for providing a hard-coated polymer film provided with the UV curable hard-coat of any one of the preceding claims. The polymer film is for example polycarbonate film. A further aspect of the invention relates to a hard-coated polymer film provided with the UV curable hard-coat of the invention. An aspect of the invention relates to use of the hard-coated polymer film provided with the UV curable hard-coat according to the invention in the manufacturing of a formed article or object such as a thermo-formed article or object and/or of a moulded article or object such as an injection-moulded article or object, preferably an article or object which comprises the hard-coated polymer film provided with the UV curable hard-coat which is first formed and then back-moulded such as back injection moulded. The invention also relates to an article or an object comprising a polycarbonate film containing a UV curable hard-coat according to the invention, wherein the article or object is manufactured using back injection-moulding or in-mould electronics.

### TECHNICAL FIELD

The invention relates to a UV curable hard-coat for a polymer film or polymer sheet, more specifically for a polymer film or sheet such as a polycarbonate film or sheet, the UV curable hard-coat comprising an aliphatic urethane acrylate oligomer, a hexa-functional aliphatic urethane acrylate oligomer, a photo-initiator and an organic solvent. The UV curable hard-coat further may comprise a flow modifier. A second aspect of the invention relates to a method for providing a hard-coated polymer film or sheet provided with the UV curable hard-coat of the invention, the method comprising the steps of providing a UV curable hard-coat according to the invention; providing a polymer film or sheet; coating the polymer film or sheet with the UV curable hard-coat; and curing the coated polymer film or sheet with UV radiation, therewith providing the hard-coated polymer film or sheet provided with the UV curable hard-coat of the invention. The polymer film or sheet is for example polycarbonate film or sheet. A further aspect of the invention relates to a hard-coated polymer film or sheet provided with the UV curable hard-coat of the invention and obtained with the method of the invention or obtainable with the method of the invention. An aspect of the invention relates to use of the hard-coated polymer film or sheet provided with the UV curable hard-coat according to the invention in the manufacturing of a formed object or part such as a thermo-formed article or object or part and/or of a moulded object or part such as an injection-moulded object, preferably an object which comprises the hard-coated polymer film or sheet provided with the UV curable hard-coat which is first formed and then back moulded or back injection moulded. In particular, the invention relates to an object or an article or a part that encompasses a polymer film or sheet that is provided with a UV curable hard-coat, preferably a hard-coated polycarbonate film or sheet of the invention, wherein the object or the article or the part is manufactured with a process comprising in-mould electronics, optionally preceded by a forming step.

### BACKGROUND

Manufacturers of polymer-film comprising articles and -parts such as mobile phones, control panels, automotive applications, demand and require polymer film which meets high quality measures. An example are the stringent hardness criteria set by automotive industry. In addition, such polymer film, for example polycarbonate film, should meet high standards relating to polymer film formability, applicability of the film in moulding processes, and relating to chemical resistance of the film surface. In addition, these hi-tech industries, e.g. automotive industry, mobile phone manufacturing, domestic control panels applications, etc., demand constant quality, robust manufacturing processes when the application of the high quality polycarbonate film is concerned, and polymer film that does not demand much attention when maintenance of previous set quality standards are considered.

Despite these demands for robust, hard, chemical resistant, easy-to-apply polymer sheets and films such as polycarbonate film, for application in car-, phone-, control panel manufacturing, etc., still currently available polycarbonate films suitable for implication in such manufacturing processes, require laborious processing steps and require the purchase and maintenance of machinery specifically mandatory to provide and maintain polymer film at the required quality with regard to e.g. hardness, chemical resistance. That is to say, currently available polycarbonate film for polymer-film comprising article manufacturing is film provided with a hard-coat that is typically UV cured in a first necessary step of providing and keeping polymer film with the required specifications, said first UV curing performed typically directly after hard-coat polycarbonate film production at the site of manufacturing of film. Then, subsequently the hard-coat polycarbonate film is typically transferred to customers, e.g. car dashboard parts manufacturers, mobile phone casing manufacturers, control panel manufacturers, etc. Typically, the hard-coat polycarbonate film is subjected to a forming step. Hard-coat polycarbonate films now available do require a necessary second UV curing step after the forming of the film, in order to meet the stringent industry criteria such as those set in the ASTM D1044-13 industry standard and in automotive norms such as VW TL226 (\NV/Porsche official test norm for automotive interior parts) and DBL9202 (Daimler Benz official test norm for automotive interior parts). This induces the necessity to conduct crucial and additional steps as part of the manufacturing process and requires measures to handle formed film before and after the forming process with high care when avoidance of scratches, contacting film surfaces, applying pressure onto the film, etc. are concerned. Only after a cumbersome second UV curing step, requiring UV curing equipment designed and suitable for the purpose, results in a formed film which can be treated with reduced caution when damaging the surface of the formed polycarbonate film is regarded. After all, such currently available film would not meet the high quality standards if the requirement of the second UV curing step would not be obeyed.

Therefore, a solution still needs to be found that allows for a less cumbersome and less critical process for applying polymer film in e.g. forming processes and moulding processes for the purpose of manufacturing polymer-film comprising articles which should resist stringent hardness tests and stringent chemical resistance tests.

International patent application WO 2018/121613 A1 (Applicant: PPG COATINGS (TIANJIN) CO., LTD. (China), relates to a high-hardness anti-steel wool UV curable coating composition comprises a high-functionality UV curable polyurethane acrylate. A method of coating a substrate with the high-hardness anti-steel UV curable coating composition and the substrate coated with the same are also provided. Typically, the coating composition of WO 2018/121613 A1 comprises butyl acetate and isobutyl acetate.

### SUMMARY

A first aspect of the invention relates to a UV curable hard-coat for a polymer film, the UV curable hard-coat comprising an aliphatic urethane acrylate oligomer; a hexa-functional aliphatic urethane acrylate oligomer; a photo-initiator; and an organic solvent.

It is preferred that the UV curable hard-coat of the invention further comprises a flow modifier. An embodiment is the UV curable hard-coat of the invention, wherein the aliphatic urethane acrylate oligomer is an aliphatic urethane tri-acrylate oligomer.

According to embodiments of the invention, the UV curable hard-coat comprises an organic solvent, wherein the organic solvent is 1-methoxy-2-propanol. It is preferred that in the UV curable hard-coat of the invention the organic solvent is 1-methoxy-2-propanol.

In particular, for the UV curable hard-coat of the invention, the photo-initiator is 1-hydroxycyclohexyl phenyl ketone.

It is preferred that the UV curable hard-coat of the invention comprises the flow modifier poly-ether-modified polydimethylsiloxane, wherein the flow modifier is dissolved in xylene and iso-butanol at a 4(:)1 volume/volume ratio.

In one embodiment, the UV curable hard-coat of the invention comprises or consists of:
a. aliphatic urethane acrylate oligomer;
b. hexa-functional aliphatic urethane acrylate oligomer;
c. the photo-initiator 1-hydroxycyclohexyl phenyl ketone;
d. the organic solvent 1-methoxy-2-propanol; and
e. the flow modifier poly-ether-modified polydimethylsiloxane dissolved in xylene and iso-butanol at a 4(:)1 volume/volume ratio,
   wherein
   i) aliphatic urethane acrylate oligomer is present in the UV curable hard coat at 18.0%-19.0% based on the total mass of the UV curable hard-coat, preferably in an amount of 18.3%-18.5%;
   ii) hexa-functional aliphatic urethane acrylate oligomer is present at 14.0%-16.0% based on the total mass of the UV curable hard-coat, preferably in an amount of 14.5%-15.5%;
   iii) 1-hydroxycyclohexyl phenyl ketone is present at 0.100%-0.160% based on the total mass of the UV curable hard-coat, preferably in an amount of 0.115%-0.145%;
   iv) 1-methoxy-2-propanol is present at 62.0%-71.0% based on the total mass of the UV curable hard-coat, preferably in an amount of 65.0%-68.0%; and
   v) the flow modifier is present at 0.028%-0.036% based on the total mass of the UV curable hard-coat, preferably in an amount of 0.030%-0.034%.

Also preferred is the UV curable hard-coat of the invention wherein the aliphatic urethane acrylate oligomer is an aliphatic urethane tri-acrylate oligomer. For a preferred UV curable hard-coat of the invention, said photo-initiator is bis(2,4,6-trimethylbenzoyl)-phenyl-phosphine oxide and the organic solvent is 1,6-hexanediol di-acrylate.

The UV curable hard-coat of the invention comprises, or consists of, in preferred embodiments:

a. aliphatic urethane acrylate oligomer;
b. hexa-functional aliphatic urethane acrylate oligomer;
c. the photo-initiator bis(2,4,6-trimethylbenzoyl)-phenyl-phosphine oxide;
d. the organic solvent 1,6-hexanediol di-acrylate; and
e. the flow modifier poly-ether-modified polydimethylsiloxane dissolved in xylene and iso-butanol at a 4(:)1 volume/volume ratio,
wherein
i) aliphatic urethane acrylate oligomer is present in the UV curable hard coat at 38.0%-45.0% based on the total mass of the UV curable hard-coat, preferably in an amount of 40.0%-43.5%;
ii) hexa-functional aliphatic urethane acrylate oligomer is present at 30.0%-38.0% based on the total mass of the UV curable hard-coat, preferably in an amount of 32.0%-36.0%;
iii) bis(2,4,6-trimethylbenzoyl)-phenyl-phosphine oxide is present at 0.090%-0.130% based on the total mass of the UV curable hard-coat, preferably in an amount of 1.00%-1.15%;
iv) 1,6-hexanediol di-acrylate is present at 20.0%-32.0% based on the total mass of the UV curable hard-coat, preferably in an amount of 23.0%-28.0%; and
v) the flow modifier is present at 0.11%-0.19% based on the total mass of the UV curable hard-coat, preferably in an amount of 0.13%-0.17%.

An aspect of the invention relates to a method for providing a hard-coated polymer film provided with the UV curable hard-coat of any one of the preceding aspects and embodiments of the invention, the method comprising the steps of, or consisting of the steps of:

a. providing a UV curable hard-coat according to the invention;
b. providing a polymer film;
c. coating the polymer film of step b. with the UV curable hard-coat of step a.; and
d. curing the coated polymer film of step c. with UV radiation,
therewith providing the hard-coated polymer film provided with the UV curable hard-coat of the invention.

An embodiment is the method of the invention for providing a hard-coated polymer film provided with the UV curable hard-coat of any one of the preceding aspects and embodiments of the invention, the method comprising the steps of, or consisting of the steps of:

a. providing a UV curable hard-coat according to the invention;
b. providing a polymer film;
c. coating the polymer film of step b. with the UV curable hard-coat of step a.;
c1. thermal curing the coating that is coated on the polymer film in step c.; and
d. curing the coated polymer film of step c. with UV radiation,
therewith providing the hard-coated polymer film provided with the UV curable hard-coat of the invention. Typically, in step c1., the polymer film such as a polycarbonate film is heated at 50° C.-80° C., preferably at a temperature of lower than 58° C., such as 50° C.-57° C. or at 50° C., after step c. and before step d.

It is preferred that in the method according to the invention the polymer film of step b. is a polycarbonate film.

An aspect of the invention relates to a hard-coated polymer film provided with the UV curable hard-coat of the invention and obtained with the method of the invention or obtainable with the method of the invention.

It is part of the invention that the polymer film of the hard-coated polymer film provided with the UV curable hard-coat according to the invention, is a polycarbonate film.

An aspect of the invention is the use of the hard-coated polymer film provided with the UV curable hard-coat according to the invention in the manufacturing of a formed article such as a thermo-formed article and/or of a moulded article such as an injection-moulded article, preferably an article which comprises the hard-coated polymer film provided with the UV curable hard-coat which is first formed and then back injection-moulded.

An embodiment is the use of the invention, wherein the article is an article such as a control panel and/or an article applied in automotive applications such as a radio panel, a control panel, a HVAC control system, or a part thereof, in telecom applications such as a housing, a keypad, an outer casing for a mobile phone.

An embodiment is the use according to the invention, in the manufacturing of a moulded article, wherein the moulded article is manufactured using in-mould electronics.

An aspect of the invention relates to an article or an object comprising a polycarbonate film containing a UV curable hard-coat according to the invention, wherein the article or the object is manufactured using moulding such as back moulding, back injection-moulding or in-mould electronics.

### Definitions

The term “UV curable” has its regular scientific meaning throughout the text, and here refers to the curing of a coating composition which is applied onto a surface such as a polymer sheet or polymer film, with the aid of illuminating the polymer film surface provided with the coating composition with ultraviolet radiation.

The term “hard-coat” has its regular scientific meaning throughout the text, and here refers to a coating for a polymer film such as a polycarbonate film, which coating, after curing, meets the industry hardness standard set by one or more of car manufacturers such as Volkswagen, Ford, Mercedes, such as the automotive norms such as VW TL226 (VW/Porsche official test norm for automotive interior parts) and DBL9202 (Daimler Benz official test norm for automotive interior parts) and/or the taber abrasion test (ASTM D1044-13).

The term “Hansen Solubility Parameters” has its regular scientific meeting throughout the application, and here refers to the three parameters δD (dispersion force interactions; dispersive aspect), δP (polar force interactions; polar aspect), and δH (hydrogen bond force interactions; hydrogen-bonding aspect) for a molecule such as a solvent molecule, as for example outlined in the paper by Steven Abbott, 29 Mar. 2018, “Science-based formulation: the xl power of HSP for coatings compatibility issues” (reference for example accessible at https://coatings.specialchem.com).

### DETAILED DESCRIPTION

It is a first goal of the present invention to provide an improved UV curable hard-coat.

It is an objective of the current invention to provide a UV curable hard-coat which is accompanied by less cumbersome manufacturing requirements, for example when method steps for applying the coating is concerned and/or when the required machinery and equipment is concerned required for processing the UV curable hard-coat.

At least one of the above objectives is achieved by providing a UV curable hard-coat of the invention. At least a further objective is achieved by providing a method for manufacturing a polymer film onto which the UV curable hard-coat of the invention is applied, therewith providing a polymer sheet provided with the UV curable hard-coat of the invention.

The present invention will be described with respect to particular embodiments but the invention is not limited thereto but only by the claims.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the invention described herein can operate in other orientations than described or illustrated herein.

The embodiments of the invention described herein can operate in combination and cooperation, unless specified otherwise.

Furthermore, the various embodiments, although referred to as “preferred” or “e.g.” or “for example” or “in particular” are to be construed as exemplary manners in which the invention may be implemented rather than as limiting the scope of the invention.

The term “comprising”, used in the claims, should not be interpreted as being restricted to the elements or steps listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a coating comprising components A and B” should not be limited to a coating consisting only of components A and B, rather with respect to the present invention, the only enumerated components of the coating are component A and component B, and further the claim should be interpreted as including equivalents of those components.

In addition, reference to an element by the indefinite article “a” or “an” does not exclude the possibility that more than one of the element are present, unless the context clearly requires that there is one and only one of the elements. The indefinite article “a” or “an” thus usually means “at least one”.

While the invention has been described in terms of several embodiments, it is contemplated that alternatives, modifications, permutations and equivalents thereof will become apparent to one having ordinary skill in the art upon reading the specification. The invention is not limited in any way to the illustrated embodiments. Changes can be made without departing from the scope which is defined by the appended claims.

A first aspect of the invention relates to a UV curable hard-coat for a polymer film, the UV curable hard-coat comprising or consisting of:

a. aliphatic urethane acrylate oligomer;
b. hexa-functional aliphatic urethane acrylate oligomer;
c. a photo-initiator; and
d. an organic solvent.

An embodiment is the UV curable hard-coat of the invention, further comprising a flow modifier. An embodiment is the UV curable hard-coat of the invention, wherein the aliphatic urethane acrylate oligomer is an aliphatic urethane tri-acrylate oligomer.

An embodiment is the UV curable hard-coat of the invention, wherein the organic solvent is 1-methoxy-2-propanol. An embodiment is the UV curable hard-coat of the invention, wherein the organic solvent is any one of: 2-methoxyethanol, 2-ethoxyethanol, 2-propoxyethanol, 2-isopropoxyethanol, 2-butoxyethanol, 2-phenoxyethanol, 2-benzyloxyethanol, 1-methoxy-2-propanol, 2-(2-methoxyethoxy)ethanol, 2-(2-ethoxyethoxy)ethanol, 2-(2-butoxyethoxy)ethanol, di-propylene glycol methyl ether, or a combination thereof.

An embodiment is the UV curable hard-coat of the invention, wherein the photo-initiator is 1-hydroxycyclohexyl phenyl ketone.

An embodiment is the UV curable hard-coat of the invention, wherein the photo-initiator has Hansen Solubility Parameters: δD of 19.1, δP of 7.2 and δH of 7.8.

An embodiment is the UV curable hard-coat of the invention, wherein the flow modifier is poly-ether-modified polydimethylsiloxane. An embodiment is the UV curable hard-coat of the invention, wherein the flow modifier is poly-ether-modified polydimethylsiloxane dissolved in xylene and iso-butanol at a 4(:)1 volume/volume ratio.

Preferred is a UV curable hard-coat for a polymer film according to the invention, the hard-coat comprising

a. aliphatic urethane acrylate oligomer;
b. hexa-functional aliphatic urethane acrylate oligomer;
c. a photo-initiator; and
d. an organic solvent,
wherein the organic solvent is 1-methoxy-2-propanol or wherein the organic solvent is any one of: 2-methoxyethanol, 2-ethoxyethanol, 2-propoxyethanol, 2-isopropoxyethanol, 2-butoxyethanol, 2-phenoxyethanol, 2-benzyloxyethanol, 1-methoxy-2-propanol, 2-(2-methoxyethoxy)ethanol, 2-(2-ethoxyethoxy)ethanol, 2-(2-butoxyethoxy)ethanol, di-propyleneglycol methyl ether, or a combination thereof, and/or wherein the photo-initiator is 1-hydroxycyclohexyl phenyl ketone, and/or wherein the photo-initiator has Hansen Solubility Parameters: δD of 19.1, δP of 7.2 and δH of 7.8.

The inventors surprisingly found that such UV curable hard-coat of the invention meets the industry hardness criteria set for application of hard-coated polymer sheet or film such as coated polycarbonate film, once applied onto the surface of such polymer film and subsequently cured by a single step of irradiation by UV light. The hardness criteria met are the pencil test (ASTM D3363-5(2011)e2) and the taber abrasion test (ASTM D0144-13) with the UV curable hard-coat of the invention provided onto polycarbonate film, the film having typically a thickness of 0.25 mm. Further details on hardness of the UV curable hard-coat of the invention are provided in the Examples section here below. Herewith, by only applying a single UV curing step after provision of a polymer film surface with the UV curable hard-coat of the invention, hardness criteria are met such as criteria and standards set in automotive industry such as by car manufacturers and car interior parts manufacturers, e.g. manufacturers of dashboard applications, control panels, etc.

An embodiment is the UV curable hard-coat of the invention, wherein the aliphatic urethane acrylate oligomer is present in an amount of 9.0%-36.0% based on the total mass of the UV curable hard-coat, preferably 12.0%-30.0%, more preferably 14.0%-27.0%, most preferably 16.0%-22.0%, such as 17.0%-20.0% or 18.0%-19.0% or 16.1%-16.4%. An embodiment is the UV curable hard-coat of the invention, wherein the aliphatic urethane acrylate oligomer is present in an amount of 9.0%-36.0% based on the total mass of the UV curable hard-coat, preferably 12.0%-30.0%, more preferably 14.0%-27.0%, most preferably 16.0%-22.0%, such as 17.0%-20.0% or 18.0%-19.0%.

An embodiment is the UV curable hard-coat of the invention, wherein the aliphatic urethane acrylate oligomer is present in an amount of 5.0%-40.0% based on the total mass of the UV curable hard-coat, preferably 6.0%-38.0%, more preferably 7.0%-36.0%, most preferably 8.0%-34.0%, such as 9.0%-33.0%.

An embodiment is the UV curable hard-coat of the invention, wherein the aliphatic urethane acrylate oligomer is a tri-functional polyurethane oligomer.

An embodiment is the UV curable hard-coat of the invention, wherein the hexa-functional aliphatic urethane acrylate oligomer is present in an amount of 7.5%-30.0% based on the total mass of the UV curable hard-coat, preferably 9.0%-27.0%, more preferably 11.0%-24.0%, most preferably 13.0%-20.0%, such as 13.3%-13.6%, 14.0%-18.0% or 14.5%-16.5%. An embodiment is the UV curable hard-coat of the invention, wherein the hexa-functional aliphatic urethane acrylate oligomer is present in an amount of 7.5%-30.0% based on the total mass of the UV curable hard-coat, preferably 9.0%-27.0%, more preferably 11.0%-24.0%, most preferably 13.0%-20.0%, such as 14.0%-18.0% or 14.5%-16.5%.

An embodiment is the UV curable hard-coat of the invention, wherein the hexa-functional aliphatic urethane acrylate oligomer is present in an amount of 20.0%-55.0% based on the total mass of the UV curable hard-coat, preferably 22.0%-54.0%, more preferably 24.0%-53.0%, most preferably 25.0%-52.0%, such as 27.0%-51.0%.

An embodiment is the UV curable hard-coat of the invention, wherein the photo-initiator is present in an amount of 0.26%-0.75% based on the total mass of the UV curable hard-coat, preferably 0.40%-0.70%, more preferably 0.50%-0.65%, most preferably 0.54%-0.63%, such as 0.56%-0.61% or 0.58%-0.60%. An embodiment is the UV curable hard-coat of the invention, wherein the photo-initiator is present in an amount of 0.065%-0.26% based on the total mass of the UV curable hard-coat, preferably 0.080%-0.22%, more preferably 0.10%-0.19%, most preferably 0.115%-0.160%, such as 0.120%-0.150% or 0.125%-0.140%.

An embodiment is the UV curable hard-coat of the invention, wherein the photo-initiator is present in an amount of 0.75%-3.2% based on the total mass of the UV curable hard-coat, preferably 1.0%-3.0%, more preferably 1.2%-2.8%, most preferably 1.5%-2.6%, such as 2.0%-2.5%.

An embodiment is the UV curable hard-coat of the invention, wherein the flow modifier is present in an amount of 0.04%-0.30% based on the total mass of the UV curable hard-coat, preferably 0.08%-0.20%, more preferably 0.10%-0.18%, most preferably 0.12%-0.16%, such as 0.13%-0.16% or 0.12%-0.15%. An embodiment is the UV curable hard-coat of the invention, wherein the flow modifier is present in an amount of 0.016%-0.064% based on the total mass of the UV curable hard-coat, preferably 0.020%-0.050%, more preferably 0.024%-0.045%, most preferably 0.028%-0.040%, such as 0.030%-0.035% or 0.031%-0.033%.

An embodiment is the UV curable hard-coat of the invention, wherein the organic solvent is 1-methoxy-2-propanol and wherein the organic solvent is present in an amount of 33.0%-84.0% based on the total mass of the UV curable hard-coat, preferably 60.0%-75.0%, more preferably 63.0%-72.0%, most preferably 65.0%-70.0%. An embodiment is the UV curable hard-coat of the invention, wherein the organic solvent is 1-methoxy-2-propanol and wherein the organic solvent is present in an amount of 33.0%-84.0% based on the total mass of the UV curable hard-coat, preferably 60.0%-73.0%, more preferably 63.0%-70.0%, most preferably 65.0%-68.0%.

An embodiment is the UV curable hard-coat of the invention, wherein the organic solvent is -methoxy-2-propanol or any one of: 2-methoxyethanol, 2-ethoxyethanol, 2-propoxyethanol, 2-isopropoxyethanol, 2-butoxyethanol, 2-phenoxyethanol, 2-benzyloxyethanol, 1-methoxy-2-propanol, 2-(2-methoxyethoxy)ethanol, 2-(2-ethoxyethoxy)ethanol, 2-(2-butoxyethoxy)ethanol, di-propyleneglycol methyl ether, or a combination thereof, and wherein the organic solvent is present in an amount of 20.0%-70.0% based on the total mass of the UV curable hard-coat, preferably 25.0%-60.0%, more preferably 30.0%-50.0%, most preferably 35.0%-40.0%.

An embodiment is the UV curable hard-coat of the invention, wherein the hard-coat comprises:

a. aliphatic urethane acrylate oligomer, preferably a tri-functional urethane oligomer;
b. any one of di-, tri-, tetra-, penta- or hexa-functional aliphatic urethane acrylate oligomer, preferably tetra-, penta- or hexa-functional aliphatic urethane acrylate oligomer, more preferable tetra- or penta-functional aliphatic urethane acrylate oligomer, most preferable hexa-functional aliphatic urethane acrylate oligomer;
c. a photo-initiator, preferably the photo-initiator 1-hydroxycyclohexyl phenyl ketone;
d. the organic solvent is selected from any one of: 1-methoxy-2-propanol, 2-methoxyethanol, 2-ethoxyethanol, 2-propoxyethanol, 2-isopropoxyethanol, 2-butoxyethanol, 2-phenoxyethanol, 2-benzyloxyethanol, 1-methoxy-2-propanol, 2-(2-methoxyethoxy)ethanol, 2-(2-ethoxyethoxy)ethanol, 2-(2-butoxyethoxy)ethanol, di-propyleneglycol methyl ether, or a combination thereof, and preferably the solvent is 1-methoxy-2-propanol; and
e. the flow modifier poly-ether-modified polydimethylsiloxane, preferably the flow modifier poly-ether-modified polydimethylsiloxane dissolved in xylene and iso-butanol at a 4(:)1 volume/volume ratio,

wherein

i) aliphatic urethane acrylate oligomer is present in the UV curable hard coat at 15%-10% or at 18.0%-19.0% based on the total mass of the UV curable hard-coat, preferably in an amount of 18.3%-18.5%, more preferably in an amount of 15.5%-17%;
ii) hexa-functional aliphatic urethane acrylate oligomer is present at 12%-14% or at 14.0%-16.0% based on the total mass of the UV curable hard-coat, preferably in an amount of 14.5%-15.5%, more preferably in an amount of 12.5%-13.5%;
iii) 1-hydroxycyclohexyl phenyl ketone is present at 0.100%-0.160% or at 0.40-0.65% based on the total mass of the UV curable hard-coat, preferably in an amount of 0.115%-0.145%, more preferably in an amount of 0.55%-0.60%;
iv) 1-methoxy-2-propanol is present at 62.0%-71.0% or at 65.0%-80.0% based on the total mass of the UV curable hard-coat, preferably in an amount of 65.0%-68.0%, more preferably in an amount of 67.0%-73.0%; and
v) the flow modifier is present at 0.028%-0.036% based on the total mass of the UV curable hard-coat, preferably in an amount of 0.030%-0.034%.

An embodiment is the UV curable hard-coat of the invention, wherein the hard-coat comprises or consists of:

a. aliphatic urethane acrylate oligomer;
b. hexa-functional aliphatic urethane acrylate oligomer;
c. the photo-initiator 1-hydroxycyclohexyl phenyl ketone;
d. the organic solvent 1-methoxy-2-propanol; and
e. the flow modifier poly-ether-modified polydimethylsiloxane dissolved in xylene and iso-butanol at a 4(:)1 volume/volume ratio,
wherein
i) aliphatic urethane acrylate oligomer is present in the UV curable hard coat at 18.0%-19.0% based on the total mass of the UV curable hard-coat, preferably in an amount of 18.3%-18.5%;
ii) hexa-functional aliphatic urethane acrylate oligomer is present at 14.0%-16.0% based on the total mass of the UV curable hard-coat, preferably in an amount of 14.5%-15.5%;
iii) 1-hydroxycyclohexyl phenyl ketone is present at 0.100%-0.160% based on the total mass of the UV curable hard-coat, preferably in an amount of 0.115%-0.145%;
iv) 1-methoxy-2-propanol is present at 62.0%-71.0% based on the total mass of the UV curable hard-coat, preferably in an amount of 65.0%-68.0%; and
v) the flow modifier is present at 0.028%-0.036% based on the total mass of the UV curable hard-coat, preferably in an amount of 0.030%-0.034%.

An embodiment is the UV curable hard-coat of the invention, wherein the aliphatic urethane acrylate oligomer is an aliphatic urethane tri-acrylate oligomer.

Unlike known UV curable hard-coats known in e.g. car manufacturing industry, the current UV curable hard-coat of the invention already meets the industry standard hardness criteria, which should be met before a polymer sheet provided with the UV curable hard-coat is applicable for, for example, manufacturing of parts applied in e.g. the interior of cars, for mobile phone production, control panels, etc., only after a single UV curing step, even after the polymer film, e.g. a polycarbonate film, is formed after being provided with the UV curable hard-coat of the invention. The current UV curable hard-coats known to the skilled person require two UV curing steps, before hardness criteria are met: a first UV curing step directly after applying the hard-coat onto a polymer film surface, and a second UV curing step after the coated film has been formed. Thus, applying the UV curable hard-coat of the invention is less cumbersome since less method steps for using the coating are mandatory, and manufacturers of articles comprising a polymer film provided with a UV curable hard-coat of the invention, who are typically purchasing from a third party a polycarbonate film that has previously been coated with a UV curable hard-coat elsewhere, do not need UV curing equipment and machinery, since with the application of polymer film coated with the UV curable hard-coat of the invention, a second UV curing step after processing of the film in an article manufacturing process, such as forming, is now superfluous due to the inventive coating composition.

An embodiment is the UV curable hard-coat according to the invention, wherein the photo-initiator is bis(2,4,6-trimethylbenzoyl)-phenyl-phosphine oxide and the organic solvent is 1,6-hexanediol di-acrylate. Such UV curable hard-coat of the invention comprising the photo-initiator bis(2,4,6-trimethylbenzoyl)-phenyl-phosphine oxide and the organic solvent 1,6-hexanediol di-acrylate, typically does not comprise the photo-initiator 1-hydroxycyclohexyl phenyl ketone, nor the organic solvent 1-methoxy-2-propanol.

Such a UV curable hard-coat of the invention, comprising the photo-initiator bis(2,4,6-trimethylbenzoyl)-phenyl-phosphine oxide and the organic solvent 1,6-hexanediol di-acrylate, is an example of a further coating composition meeting standard hardness criteria already only after a single UV curing step, irrespective of whether or not a polymer film such as a polycarbonate film which is coated with the UV curable hard-coat of the invention, is subjected to e.g. a forming step in the process of manufacturing articles comprising the hard-coat polymer film.

An embodiment is the UV curable hard-coat of the invention, wherein the photo-initiator is bis(2,4,6-trimethylbenzoyl)-phenyl-phosphine oxide and the organic solvent is 1,6-hexanediol di-acrylate, and wherein the aliphatic urethane acrylate oligomer is present in an amount of 21.0%-83.0% based on the total mass of the UV curable hard-coat, preferably 31.0%-70.0%, more preferably 34.0%-60.0%, most preferably 37.0%-50.0%, such as 39.0%-46.0% or 40.0%-44.0%.

An embodiment is the UV curable hard-coat of the invention, wherein the aliphatic urethane acrylate oligomer is present in an amount of 5.0%-40.0% based on the total mass of the UV curable hard-coat, preferably 6.0%-38.0%, more preferably 7.0%-36.0%, most preferably 8.0%-34.0%, such as 9.0%-33.0%.

An embodiment is the UV curable hard-coat of the invention, wherein the photo-initiator is bis(2,4,6-trimethylbenzoyl)-phenyl-phosphine oxide and the organic solvent is 1,6-hexanediol di-acrylate, and wherein the hexa-functional aliphatic urethane acrylate oligomer is present in an amount of 17.0%-68.0% based on the total mass of the UV curable hard-coat, preferably 21.0%-55.0%, more preferably 25.0%-46.0%, most preferably 30.0%-40.0%, such as 31.0%-38.0% or 32.0%-38.0%. An embodiment is the UV curable hard-coat of the invention, wherein the hexa-functional aliphatic urethane acrylate oligomer is present in an amount of 17.0%-68.0% based on the total mass of the UV curable hard-coat, preferably 21.0%-55.0%, more preferably 225.0%-46.0%, most preferably 22.5.0%-40.0%, such as 20.0%-38.0% or 23.0%-38.0%.

An embodiment is the UV curable hard-coat of the invention, wherein the photo-initiator is present in an amount of 0.050%-2.20% based on the total mass of the UV curable hard-coat, preferably 0.070%-1.80%, more preferably 0.085%-1.50%, most preferably 0.095%-1.30%, such as 0.100%-1.20% or 0.105%-1.10%. An embodiment is the UV curable hard-coat of the invention, wherein the photo-initiator is bis(2,4,6-trimethylbenzoyl)-phenyl-phosphine oxide and the organic solvent is 1,6-hexanediol di-acrylate, and wherein the photo-initiator is present in an amount of 0.050%-2.20% based on the total mass of the UV curable hard-coat, preferably 0.070%-1.80%, more preferably 0.085%-1.50%, most preferably 0.095%-0.130%, such as 0.100%-0.120% or 0.105%-0.110%.

An embodiment is the UV curable hard-coat of the invention, wherein the photo-initiator is present in an amount of 1.5%-3.0% based on the total mass of the UV curable hard-coat, preferably 1.6%-2.8%, more preferably 1.7%-2.7%, most preferably 1.8%-2.6%, such as 2.0% 2.5%.

An embodiment is the UV curable hard-coat of the invention, wherein the photo-initiator is bis(2,4,6-trimethylbenzoyl)-phenyl-phosphine oxide and the organic solvent is 1,6-hexanediol di-acrylate, and wherein the flow modifier is present in an amount of 0.070%-0.40% based on the total mass of the UV curable hard-coat, preferably 0.090%-0.30%, more preferably 0.100%-0.28%, most preferably 0.120%-0.24%, such as 0.130%-0.22% or 0.135%-0.20%.

An embodiment is the UV curable hard-coat of the invention, wherein the organic solvent is 1,6-hexanediol di-acrylate and wherein the organic solvent is present in an amount of 8.0%-63.0% based on the total mass of the UV curable hard-coat, preferably 12.0%-50.0%, more preferably 16.0%-40.0%, most preferably 20.0%-35.0%, such as 28.0%-32.0%. An embodiment is the UV curable hard-coat of the invention, wherein the photo-initiator is bis(2,4,6-trimethylbenzoyl)-phenyl-phosphine oxide and the organic solvent is 1,6-hexanediol di-acrylate and wherein the organic solvent is present in an amount of 8.0%-63.0% based on the total mass of the UV curable hard-coat, preferably 12.0%-50.0%, more preferably 16.0%-40.0%, most preferably 20.0%-35.0%, such as 28.0%-32.0%. An embodiment is the UV curable hard-coat of the invention, wherein the photo-initiator is bis(2,4,6-trimethylbenzoyl)-phenyl-phosphine oxide and the organic solvent is 1,6-hexanediol di-acrylate, and wherein the organic solvent is present in an amount of 8.0%-63.0% based on the total mass of the UV curable hard-coat, preferably 12.0%-50.0%, more preferably 16.0%-40.0%, most preferably 20.0%-35.0%.

An embodiment is the UV curable hard-coat of the invention, wherein the hard-coat comprises:

a. aliphatic urethane acrylate oligomer;
b. hexa-functional aliphatic urethane acrylate oligomer;
c. the photo-initiator bis(2,4,6-trimethylbenzoyl)-phenyl-phosphine oxide;
d. the organic solvent 1,6-hexanediol di-acrylate; and
e. the flow modifier poly-ether-modified polydimethylsiloxane, preferably dissolved in xylene and iso-butanol, preferably at a 4(:)1 volume/volume ratio,

wherein

i) aliphatic urethane acrylate oligomer is present in the UV curable hard coat at 38.0%-45.0% based on the total mass of the UV curable hard-coat, preferably in an amount of 40.0%-43.5%;
ii) hexa-functional aliphatic urethane acrylate oligomer is present at 30.0%-38.0% based on the total mass of the UV curable hard-coat, preferably in an amount of 32.0%-36.0%;
iii) bis(2,4,6-trimethylbenzoyl)-phenyl-phosphine oxide is present at 0.090%-0.130% based on the total mass of the UV curable hard-coat, preferably in an amount of 1.00%-1.15%;
iv) 1,6-hexanediol di-acrylate is present at 20.0%-32.0% based on the total mass of the UV curable hard-coat, preferably in an amount of 23.0%-28.0%; and
v) the flow modifier is present at 0.11%-0.19% based on the total mass of the UV curable hard-coat, preferably in an amount of 0.13%-0.17%.

An embodiment is the UV curable hard-coat of the invention, wherein the hard-coat comprises or consists of:

a. aliphatic urethane acrylate oligomer;
b. hexa-functional aliphatic urethane acrylate oligomer;
c. the photo-initiator bis(2,4,6-trimethylbenzoyl)-phenyl-phosphine oxide;
d. the organic solvent 1,6-hexanediol di-acrylate; and
e. the flow modifier poly-ether-modified polydimethylsiloxane dissolved in xylene and iso-butanol at a 4(:)1 volume/volume ratio,
wherein
i) aliphatic urethane acrylate oligomer is present in the UV curable hard coat at 38.0%-45.0% based on the total mass of the UV curable hard-coat, preferably in an amount of 40.0%-43.5%;
ii) hexa-functional aliphatic urethane acrylate oligomer is present at 30.0%-38.0% based on the total mass of the UV curable hard-coat, preferably in an amount of 32.0%-36.0%;
iii) bis(2,4,6-trimethylbenzoyl)-phenyl-phosphine oxide is present at 0.090%-0.130% based on the total mass of the UV curable hard-coat, preferably in an amount of 1.00%-1.15%;
iv) 1,6-hexanediol di-acrylate is present at 20.0%-32.0% based on the total mass of the UV curable hard-coat, preferably in an amount of 23.0%-28.0%; and
v) the flow modifier is present at 0.11%-0.19% based on the total mass of the UV curable hard-coat, preferably in an amount of 0.13%-0.17%.

An embodiment is the UV curable hard-coat of the invention, wherein the hard-coat comprises:

a. aliphatic urethane acrylate oligomer, preferably a tri-functional urethane oligomer;
b. any one of di-, tri-, tetra-, penta- or hexa-functional aliphatic urethane acrylate oligomer, preferably tetra-, penta- or hexa-functional aliphatic urethane acrylate oligomer, more preferable tetra- or penta-functional aliphatic urethane acrylate oligomer, most preferable hexa-functional aliphatic urethane acrylate oligomer;
c. the photo-initiator bis(2,4,6-trimethylbenzoyl)-phenyl-phosphine oxide;
d. the organic solvent 1,6-hexanediol di-acrylate; and
e. the flow modifier poly-ether-modified polydimethylsiloxane, preferably dissolved in xylene and iso-butanol, preferably at a 4(:)1 volume/volume ratio,
wherein
i) aliphatic urethane acrylate oligomer is present in the UV curable hard coat at 38.0%-45.0% based on the total mass of the UV curable hard-coat, preferably in an amount of 40.0%-43.5%;
ii) the di-, tri-, tetra-, penta- or hexa-functional aliphatic urethane acrylate oligomer, preferably tetra-, penta- or hexa-functional aliphatic urethane acrylate oligomer, more preferable tetra- or penta-functional aliphatic urethane acrylate oligomer, most preferable hexa-functional aliphatic urethane acrylate oligomer is present at 30.0%-38.0% based on the total mass of the UV curable hard-coat, preferably in an amount of 32.0%-36.0%;
iii) bis(2,4,6-trimethylbenzoyl)-phenyl-phosphine oxide is present at 0.090%-0.130% based on the total mass of the UV curable hard-coat, preferably in an amount of 1.00%-1.15%;
iv) 1,6-hexanediol di-acrylate is present at 20.0%-32.0% based on the total mass of the UV curable hard-coat, preferably in an amount of 23.0%-28.0%; and
v) the flow modifier is present at 0.11%-0.19% based on the total mass of the UV curable hard-coat, preferably in an amount of 0.13%-0.17%.

The UV curable hard-coats of the invention provide a polymer film such as a polycarbonate film or sheet with a hard surface unprecedented in e.g. mobile phone manufacturing industry, control panel manufacturing, car interior manufacturing such as dashboard applications manufacturing, only after a single step of UV curing, therewith making nowadays standard two-step UV curing superfluous, therewith saving time, saving financial resources (no need for UV curing apparatus at the side of processing hard-coated polycarbonate film into e.g. formed sheet, etc.), and providing a less cumbersome and more smooth and easy applicable process for applying polymer film provided with a hard coat.

An embodiment is the UV curable hard-coat of the invention, wherein the aliphatic urethane acrylate oligomer is an aliphatic urethane tri-acrylate oligomer.

A second aspect of the invention relates to a method for providing a hard-coated polymer film provided with the UV curable hard-coat of the invention, the method comprising the steps of, or consisting of the steps of:

a. providing a UV curable hard-coat according to the invention;
b. providing a polymer film;
c. coating the polymer film of step b. with the UV curable hard-coat of step a.; and
d. curing the coated polymer film of step c. with UV radiation,
therewith providing the hard-coated polymer film provided with the UV curable hard-coat of the invention.

An embodiment is the method of the invention for providing a hard-coated polymer film provided with the UV curable hard-coat of any one of the preceding aspects and embodiments of the invention, the method comprising the steps of, or consisting of the steps of:

a. providing a UV curable hard-coat according to the invention;
b. providing a polymer film;
c. coating the polymer film of step b. with the UV curable hard-coat of step a.;
c1. thermal curing the coating that is coated on the polymer film in step c.; and
d. curing the coated polymer film of step c. with UV radiation,
therewith providing the hard-coated polymer film provided with the UV curable hard-coat of the invention. Typically, in step c1., the polymer film such as a polycarbonate film is heated at 50° C.-80° C., preferably at a temperature of lower than 58° C., such as 50° C.-57° C. or at 50° C., after step c. and before step d.

The polymer film surface onto which the UV curable hard-coat of the invention is applied followed by a single UV curing step, displays high hardness and meets criteria set by hard-coated polycarbonate film processing industry, such as the ASTM D1044-13 and ASTM D3363-5(2011)e2 criteria. Furthermore, adhesion of the UV curable hard-coat on polymer films such as the polycarbonate film surface meets the DIN 53151; 1981-05 criteria after a standard VW TL226 ageing test. See for further details the example outlined in the Example section, here below.

An embodiment is the method of the invention, wherein the polymer film of step b. is a polycarbonate film. For example, the polymer film such as a polycarbonate film has a thickness of between 4 micrometer and 12 micrometer, such as 5-10 micrometer.

An embodiment is the method of the invention, wherein the polymer film such as a polycarbonate film has a thickness of 0.10 mm-0.40 mm, preferably 0.15 mm-0.30 mm, such as 0.25 mm.

An embodiment is the method of the invention, wherein the polymer film such as a polycarbonate film has an essentially uniform thickness of between 0.10 mm and 0.40 mm, preferably between 0.15 mm and 0.30 mm, such as about 0.25 mm or 0.25 mm.

An embodiment is the method of the invention, wherein the polymer film such as a polycarbonate film has an essentially non-uniform thickness of between 0.10 mm and 0.40 mm, preferably between 0.15 mm and 0.30 mm, such as 0.25 mm or less, for example between 0.10 mm and 0.25 mm. Typically, polymer film such as the polycarbonate film has a uniform thickness of about 0.25 mm, since a film having such a thickness is an industry standard. Typically, the polymer film such as a polycarbonate film obtained with the method of the invention essentially has the same thickness compared with the film thickness before the film was subjected to the method of the invention. Of course, the skilled person will appreciate that the thickness of the polymer film such as a polycarbonate film that is provided with the coating and that is thus subjected to the method of the invention is typically increased to the extent of the thickness of the layer of the UV curable hard-coat of the invention, compared to the thickness of the film before the method is applied. Typically, the thickness of the coating is in the range between 5 micrometer and 100 micrometer, such as 10 micrometer, 25 micrometer.

An embodiment is the method of the invention, wherein the polymer material of step b. is provided as a polycarbonate sheet.

An embodiment is the method of the invention, wherein the polymer sheet such as a polycarbonate sheet has a thickness of over 0.25 mm, such as 0.30 mm-30 mm, preferably 0.80 mm-20 mm, such as 3 mm and 12 mm.

An embodiment is the method of the invention, wherein the applied coating technique of step c. is slot die coating or film coating and/or any coating technique suitable for the provision of a transparent coating. An embodiment is therefore the method of the invention, wherein the method of coating is any of flow coating, spray coating, ink jet coating, dip coating, spin coating, slot die coating or film coating, preferably slot die coating or film coating. These coating techniques are generally applied by the skilled person when a polymer film surface or sheet surface has to be provided with a transparent coating.

The inventors established that the UV-curable hard coatings of the invention equally and strongly adhere to a variety of different types of polymer films and film materials such as polycarbonate films, PMMA films, co-extruded films such as a co-extruded film comprising polycarbonate and PMMA, multi-layer polymer films such as a composite comprising a layer of polycarbonate and a layer of PET. Testing the firmness of the adhesion of the coated hard-coat of the invention onto these types of films revealed that the hard-coat of the invention was coated similarly strong or equally strong on the surfaces of these further types of polymer film, when compared to the coating strength and strong binding of the coating when the hard-coat of the invention is coated onto a polycarbonate film. Thus, to the surprise of the inventors, the UV-curable hard-coat of the invention is suitable for coating a wide variety of different polymer film surfaces. Herewith, the invention provides a universal hard-coat for providing a widespread scope of different polymer films with a strong and chemically resistant hard-coat that is resistant to cracking when subjected to elongation by thermofolding and that is resistant to cracking when subjected to outer fibre strain. In addition, the invention provides a method for providing a polymer film such as a PC film, a PMMA film, a composite film or a co-extruded film, with a UV curable hard-coat of the invention.

An embodiment is the method of the invention, wherein the UV curable hard-coat of step a. is any one of the UV curable hard-coats according to the invention wherein the UV curable hard-coat comprises the photo-initiator 1-hydroxycyclohexyl phenyl ketone and the organic solvent 1-methoxy-2-propanol, and/or wherein in step b. the polymer film is polycarbonate film with a thickness of 0.20-0.30 mm such as 0.25 mm, and/or wherein in step c. the coating is slot die coating, and/or wherein the curing of step d. is by irradiating the coated polymer film of step c. with a mercury vapor H-bulb UV irradiation source, such as a UV irradiation source providing the energies: UVA, 648 mJ/cm², 304 mW/cm²; UVB, 579 mJ/cm², 280 mW/cm²; UVC, 174 mJ/cm², 84 mW/cm²; UVV, 490 mJ/cm². Alternatively, in the method of the invention, the applied method or technique of coating is any of flow coating, spray coating, ink jet coating, dip coating, spin coating, slot die coating or film coating, preferably slot die coating or film coating.

An embodiment is the method of the invention, wherein the UV curable hard-coat of step a. is a UV curable hard-coat wherein the hard-coat comprises or consists of:

a. aliphatic urethane acrylate oligomer;
b. hexa-functional aliphatic urethane acrylate oligomer;
c. the photo-initiator 1-hydroxycyclohexyl phenyl ketone;
d. the organic solvent 1-methoxy-2-propanol; and
e. the flow modifier poly-ether-modified polydimethylsiloxane dissolved in xylene and iso-butanol at a 4(:)1 volume/volume ratio,
wherein
i) aliphatic urethane acrylate oligomer is present in the UV curable hard coat at 18.0%-19.0% based on the total mass of the UV curable hard-coat, preferably in an amount of 18.3%-18.5%;
ii) hexa-functional aliphatic urethane acrylate oligomer is present at 14.0%-16.0% based on the total mass of the UV curable hard-coat, preferably in an amount of 14.5%-15.5%;
iii) 1-hydroxycyclohexyl phenyl ketone is present at 0.100%-0.160% based on the total mass of the UV curable hard-coat, preferably in an amount of 0.115%-0.145%;
iv) 1-methoxy-2-propanol is present at 62.0%-71.0% based on the total mass of the UV curable hard-coat, preferably in an amount of 65.0%-68.0%; and
v) the flow modifier is present at 0.028%-0.036% based on the total mass of the UV curable hard-coat, preferably in an amount of 0.030%-0.034%,
and wherein in step b. the polymer film is polycarbonate film with a thickness of 0.25 mm and wherein in step c. the coating is slot die coating and wherein the curing of step d. is by irradiating the coated polymer film of step c. with a mercury vapor H-bulb UV irradiation source providing the energies: UVA, 648 mJ/cm², 304 mW/cm²; UVB, 579 mJ/cm², 280 mW/cm²; UVC, 174 mJ/cm², 84 mW/cm²; UVV, 490 mJ/cm². Also preferred is any coating technique applied in the method of the invention, selected from flow coating, spray coating, ink jet coating, dip coating, spin coating, slot die coating or film coating, preferably slot die coating or film coating. In general, any coating technique for providing a transparent coating is suitable for application in any of the methods of the invention.

Typically, the hardness of a polymer film such as a polycarbonate film surface provided with a UV curable hard-coat of the invention is less than 10%, as assessed according to the taber abrasion test (ASTM D1044-13), in which delta haze after 100 cycles of taber abrasion is determined, such as less than 9%, less than 8.5%, such as 7.5%-8.4%, or about 7.8% to about 8.3%. An embodiment is the polymer film such as the polycarbonate film provided with a UV curable hard-coat of the invention, wherein the surface hardness of the film surface onto which the UV curable hard-coat of the invention is coated, following by a single UV curing step, is less than 11% as assessed according to the taber abrasion test (ASTM D1044-13), preferably less than 10%, less than 9%, less than 8.5%, such as 7%-9%, 7.7%-8.4%.

An embodiment is the method of the invention, wherein the UV curable hard-coat of step a. is any one of the UV curable hard-coats according to the invention wherein the photo-initiator is bis(2,4,6-trimethylbenzoyl)-phenyl-phosphine oxide and the organic solvent is 1,6-hexanediol di-acrylate, and/or wherein in step b. the polymer film is polycarbonate film with a thickness of 0.20-0.30 mm such as 0.25 mm, and/or wherein in step c. the coating is film coating, and/or wherein the curing of step d. is by irradiating the coated polymer film of step c. with a UV 395 nm LED lamp.

An embodiment is the method of the invention, wherein the UV curable hard-coat of step a. is any one of the UV curable hard-coats according to the invention wherein the photo-initiator is bis(2,4,6-trimethylbenzoyl)-phenyl-phosphine oxide and the organic solvent is 1,6-hexanediol di-acrylate, and/or wherein in step b. the polymer film is polycarbonate film with a thickness of 0.20-0.30 mm such as 0.25 mm, and/or wherein in step c. the coating is film coating, and/or wherein the curing of step d. is by irradiating the coated polymer film of step c. with a UV LED lamp irradiating UV light in the wavelength area 320 nm-400 nm, preferably 360 nm-400 nm, more preferably with a UV 365 nm LED lamp, most preferably with a UV 395 nm LED lamp.

An embodiment is the method of the invention, wherein the UV curable hard-coat of step a. is any one of the UV curable hard-coats according to the invention wherein the hard-coat comprises or consists of:

a. aliphatic urethane acrylate oligomer;
b. hexa-functional aliphatic urethane acrylate oligomer;
c. the photo-initiator bis(2,4,6-trimethylbenzoyl)-phenyl-phosphine oxide;
d. the organic solvent 1,6-hexanediol di-acrylate; and
e. the flow modifier poly-ether-modified polydimethylsiloxane dissolved in xylene and iso-butanol at a 4(:)1 volume/volume ratio,
wherein
i) aliphatic urethane acrylate oligomer is present in the UV curable hard coat at 38.0%-45.0% based on the total mass of the UV curable hard-coat, preferably in an amount of 40.0%-43.5%;
ii) hexa-functional aliphatic urethane acrylate oligomer is present at 30.0%-38.0% based on the total mass of the UV curable hard-coat, preferably in an amount of 32.0%-36.0%;
iii) bis(2,4,6-trimethylbenzoyl)-phenyl-phosphine oxide is present at 0.090%-0.130% based on the total mass of the UV curable hard-coat, preferably in an amount of 1.00%-1.15%;
iv) 1,6-hexanediol di-acrylate is present at 20.0%-32.0% based on the total mass of the UV curable hard-coat, preferably in an amount of 23.0%-28.0%; and
v) the flow modifier is present at 0.11%-0.19% based on the total mass of the UV curable hard-coat, preferably in an amount of 0.13%-0.17%,
and wherein in step b. the polymer film is polycarbonate film with a thickness of 0.25 mm and wherein in step c. the coating is film coating and wherein the curing of step d. is by irradiating the coated polymer film of step c. with a UV 395 nm LED lamp.

An embodiment is the method of the invention, wherein the UV curable hard-coat of step a. is any one of the UV curable hard-coats according to the invention wherein the hard-coat comprises or consists of:

a. aliphatic urethane acrylate oligomer;
b. hexa-functional aliphatic urethane acrylate oligomer;
c. the photo-initiator bis(2,4,6-trimethylbenzoyl)-phenyl-phosphine oxide;
d. the organic solvent 1,6-hexanediol di-acrylate; and
e. the flow modifier poly-ether-modified polydimethylsiloxane dissolved in xylene and iso-butanol at a 4(:)1 volume/volume ratio,
wherein
i) aliphatic urethane acrylate oligomer is present in the UV curable hard coat at 38.0%-45.0% based on the total mass of the UV curable hard-coat, preferably in an amount of 40.0%-43.5%;
ii) hexa-functional aliphatic urethane acrylate oligomer is present at 30.0%-38.0% based on the total mass of the UV curable hard-coat, preferably in an amount of 32.0%-36.0%;
iii) bis(2,4,6-trimethylbenzoyl)-phenyl-phosphine oxide is present at 0.090%-0.130% based on the total mass of the UV curable hard-coat, preferably in an amount of 1.00%-1.15%;
iv) 1,6-hexanediol di-acrylate is present at 20.0%-32.0% based on the total mass of the UV curable hard-coat, preferably in an amount of 23.0%-28.0%; and
v) the flow modifier is present at 0.11%-0.19% based on the total mass of the UV curable hard-coat, preferably in an amount of 0.13%-0.17%,
and wherein in step b. the polymer film is polycarbonate film with a thickness of 0.25 mm and wherein in step c. the coating is film coating and wherein the curing of step d. is by irradiating the coated polymer film of step c. with a UV LED lamp irradiating UV light in the wavelength area 360 nm-400 nm, preferably with a UV 395 nm LED lamp.

An embodiment is the method according to the invention wherein the UV curable hard-coat of step a. is any one of the UV curable hard-coats according to the invention wherein the photo-initiator is bis(2,4,6-trimethylbenzoyl)-phenyl-phosphine oxide and the organic solvent is 1,6-hexanediol di-acrylate, wherein the curing of step d. is at a speed of 0.37 m/min.

An embodiment is the method according to the invention wherein the UV curable hard-coat of step a. is any one of the UV curable hard-coats according to the invention wherein the photo-initiator is bis(2,4,6-trimethylbenzoyl)-phenyl-phosphine oxide and the organic solvent is 1,6-hexanediol di-acrylate, wherein the polymer film such as a polycarbonate film is heated at 50° C.-80° C., preferably at a temperature of lower than 58° C., such as 50° C.-57° C. or at 50° C., after step c. and before step d.

An embodiment is the method according to the invention wherein the UV curable hard-coat of step a. is any one of the UV curable hard-coats according to the invention wherein the photo-initiator is bis(2,4,6-trimethylbenzoyl)-phenyl-phosphine oxide and the organic solvent is 1,6-hexanediol di-acrylate, wherein the polymer film such as the polycarbonate film is heated at 50° C.-80° C., preferably at a temperature of lower than 58° C., such as 50° C.-57° C. or at 50° C., after step d. An embodiment is the method according to the invention wherein the UV curable hard-coat of step a. is any one of the UV curable hard-coats according to the invention wherein the photo-initiator is bis(2,4,6-trimethylbenzoyl)-phenyl-phosphine oxide and the organic solvent is 1,6-hexanediol di-acrylate, wherein the polymer film such as the polycarbonate film is heated at 50° C. after step d.

A third aspect of the invention relates to a hard-coated polymer film provided with the UV curable hard-coat of the invention and obtained with the method of the invention or obtainable with the method of the invention. The polymer film is preferably a polycarbonate film.

An embodiment is the hard-coated polymer film of the invention, provided with the UV curable hard-coat of the invention, wherein the polymer film is a polycarbonate film which is formable, when e.g. subjected to positive molding with a 95° angle in Niebling HPF forming process with a forming temperature of 180° C.

An embodiment is the hard-coated polymer film of the invention, provided with the UV curable hard-coat of the invention, wherein the UV curable hard-coat comprises the photo-initiator 1-hydroxycyclohexyl phenyl ketone and the organic solvent 1-methoxy-2-propanol.

An embodiment is the hard-coated polymer film of the invention, provided with the UV curable hard-coat of the invention, wherein the photo-initiator is bis(2,4,6-trimethylbenzoyl)-phenyl-phosphine oxide and the organic solvent is 1,6-hexanediol di-acrylate.

An embodiment is the hard-coated polymer film provided with the UV curable hard-coat according to the invention, wherein the polymer film is a polycarbonate film. The UV curable hard-coat either comprises the photo-initiator 1-hydroxycyclohexyl phenyl ketone and the organic solvent 1-methoxy-2-propanol, or comprises the photo-initiator bis(2,4,6-trimethylbenzoyl)-phenyl-phosphine oxide and the organic solvent 1,6-hexanediol di-acrylate.

A fourth aspect of the invention relates to the use of the hard-coated polymer film provided with the UV curable hard-coat according to the invention in the manufacturing of a formed article or a formed object such as a thermo-formed article or object and/or of a moulded article or object such as an injection-moulded article or object, preferably an article or object which comprises the hard-coated polymer film provided with the UV curable hard-coat which is first formed and then back-moulded, e.g. back injection-molded.

One of the many beneficial aspects of the UV curable hard-coat of the invention is its chemical resistance once a polymer surface such as a polycarbonate film surface is coated with the UV curable hard-coat of the invention and UV cured in a single UV curing step. The chemical resistance is for example assessed and established by performing a chemical resistance test comprising contacting a formed cavity in the coated polymer surface for 10 minutes with acetone and subsequently assessing effects on visual appearance, hardness, formability in the Niebling HPF forming process. See also the Examples section for tests demonstrating the chemical resistance (test result GTO after 7 days of exposure to acetone in a cross-hatch test, for example) of the hard-coats of the invention.

An embodiment is the use of the invention, wherein the article is an article such as a control panel and/or an article applied in automotive applications such as a radio panel, a control panel, a HVAC control system, or a part thereof, in telecom applications such as a housing, a keypad, an outer casing for a mobile phone.

Due to the ease of handling (only a single UV curing step is required at the site of hard-coated polycarbonate film manufacturing, such that end-users of such films, e.g. mobile phone manufacturers, car part manufacturers, manufacturers of control panels such as those applied for domestic applications, etc., do not have the hassle of a mandatory further UV curing step during their manufacturing process) and due to the chemical resistance, formability, high hardness of the UV curable hard-coat of the invention, once applied onto polycarbonate film and after e.g. forming, the polycarbonate film comprising UV curable hard-coated surface, the UV curable hard-coat being a coating of the invention, the UV curable hard-coat is particularly suitable for coating polymer film applied in car manufacturing, mobile phone (casing) manufacturing, control panel manufacturing, etc., where high standard apply with regard to hardness, chemical resistance, formability.

The current invention provides a formable hard-coated plastic film comprising the UV curable hard-coat of the invention, suitable for, for example, use as car interior, cockpit and display surfaces. The hard-coated polymer film, preferable a polycarbonate film, is suitable for film insert moulding using a moulding process known in the art, or is suitable for using Niebling HPF forming process. The hard-coated polycarbonate (PC) films of the invention are for example applicable for manufacturing of protected surfaces, relating to the chemical resistance, wear resistance and scratch resistant properties of the hard-coated PC film.

The hard-coated PC film of the invention is applicable for a range of forms and extends of forming. The hard-coated PC films are for example applicable for manufacturing of functional parts such as manufacturing using in-mould electronics (IME), producing capacitive switches, integrated displays and touchscreens, to name a few applications. The IME process for example encompasses the steps of functional and graphical printing which can be carried out on a 2D flat substrate which is then formed and moulded into a 3D shaped (electronic) article. IME is thus a method for structurally integrating electronics into 3D shaped objects, such objects, or articles comprising a PC film coated with the UV curable hard-coat of the invention. The hard-coated PC films are for example also applicable for manufacturing of articles provided using film insert moulding, or using first screen printing on polycarbonate film followed by forming and encompassing a subsequent step of injection moulding. The hard-coated PC films are for example also applicable for manufacturing of articles wherein the manufacturing process comprises an in-mold decoration step for providing a hard-coated PC film with a decorated surface. Last but not least, the hard-coated PC films of the invention do meet the stringent hardness requirements under the harsh testing conditions demanded by e.g. the automotive industry. These automotive test specifications are met without the requirement and necessity of a UV curing step after the hard-coated PC film of the invention is formed. This is unlike the current hard-coated PC films known today and marketed for application in manufacturing of e.g. telecom articles, automotive articles, control panels, etc. The hard-coated PC film of the invention thus combines a hardness sufficient to meet the high quality standard common in e.g. car manufacturing industry, specifically car interior manufacturing industry, with a high chemical resistance, a stable color, and capacity to be formable, with a time-saving, handling-steps saving and costs saving method for providing the hard-coated PC film, since a second UV curing step after forming of the hard-coated PC film is no longer mandatory when the hard-coated PC film of the invention is applied and is replacing current hard-coated PC film commonly applied in automotive industry.

Applying the hard-coated PC film of the invention in a moulding process such as film insert moulding has the benefit over hard-coated PC films currently known in the art, that including the addition of UV curing after the forming stage is now made superfluous due to the invention and is not required for obtaining a formed hard-coated PC film of the invention or an injection-moulded article or object, or a back injection-moulded article or object comprising said hard-coated PC film, which meets the hardness requirements demanded by e.g. automotive industry. This allows the inventors of the hard-coated PC films of the invention to produce formable films which do not demand a subsequent curing step by manufacturers of e.g. telecom parts, mobile phone housings and parts, automotive parts, car vehicle dashboard parts, when producing such hard-coated parts with the hard-coated PC film of the invention.

An embodiment is the use according to the invention, in the manufacturing of a moulded article or a moulded object, wherein the moulded article or the moulded object is manufactured using in-mould electronics.

An aspect of the invention relates to an article or an object comprising a polycarbonate film containing a UV curable hard-coat according to the invention, wherein the article or the object is manufactured using moulding such as back moulding, back injection-moulding or in-mould electronics.

In summary, the inventors provide for the first time, to the best of their knowledge, a UV curable hard-coat, which, once applied onto the surface of e.g. polycarbonate film, followed by a single UV curing step, unlike the twofold UV curing steps currently required when applying UV curable hard-coats known to the skilled person, displays excellent formability in e.g. Niebling high-pressure forming process, excellent chemical resistance, as demonstrated by unencumbered survival of contacting the coated surface for 10 minutes with acetone in a formed cavity, and has excellent hardness properties as assessed in a standard taber abrasion test and pencil hardness test. Moreover, the UV curable hard-coat of the invention is curable in a single UV curing step after coating onto a polymer surface, by applying a wide range of different UV radiation sources, unlike UV curable hard-coats known today: UV LED, Mercury H bulb. The polycarbonate film of the invention, provided with a UV curable hard-coat according to the invention is in particular suitable for manufacturing of an article or an object using a forming step and/or applying back injection-moulding and/or in-mould electronics according to the invention.

As said, International patent application WO 2018/121613 A1 (Applicant: PPG COATINGS (TIANJIN) CO., LTD. (China), relates to a UV curable coating composition comprises a high-functionality UV curable polyurethane acrylate (functionality is 10 in embodiments). Typically, the coating composition of WO 2018/121613 A1 comprises butyl acetate and isobutyl acetate.

The UV curable hard-coats of the invention are subjected to quality tests side by side together with various UV curable hard-coats according to WO 2018/121613 A1 in comparative tests, in order to assess differences in quality measures such as thermoformbility of a coating on a polymer surface, and in order to be able to demonstrate the surprising improvements achieved by the inventors when for example anti-cracking behaviour is compared under influence of thermoforming (1D, 3D).

That is to say, the coating compositions according to WO 2018/121613 A1 do not provide coatings that can be thermoformed without resulting in severely cracked coating layer, whereas in contrast, the coatings of the invention are thermoformable, providing non-cracked and clear coatings, even when elongated up to 20% (high-pressure 3D thermoforming conditions; temperature during thermoforming was 150° C.-160° C.) and when an outer fibre strain of up to 3.7% is applied on the coated surface. Indeed, the coatings of the invention are thermoformable under conditions resulting in an elongation of larger than 0% and up to 20%, such as between >5%-<20%, or from and including 0.5% up to and including 18%. Within these thermoforming limits, no cracking of the coating of the invention is observed for example coatings. In stark contrast, coatings according to WO 2018/121613 A1 already show severe cracking when similarly 3D thermofolded (thermoformed) up to an elongation of as little as 0.5% or less. The coatings obtained from the coating compositions according to WO 2018/121613 A1 already show severe cracking when an outer fibre strain of 2.5% is applied to the coatings at temperatures above the glass transition temperature of the polycarbonate on which the comparative coating was provided (at this temperature the polycarbonate becomes visco-elastic). In contrast, and to the surprise of the inventions, the coatings obtained with the method of the invention using the coating compositions of the invention do not show cracking when an outer fibre strain of 2.5% is applied to the coatings at temperatures above the glass transition temperature of the polycarbonate on which the comparative coating was provided.

These comparisons altogether demonstrate that the coatings of the invention have a surprisingly high thermoformability (thermofoldability) before cracking of the coating becomes apparent. Even when elongated up to 20% (3D thermoforming), the coating of the invention does not crack and remains transparent, and even when an outer fibre strain of 2.5%-3.7% is exerted onto the coating (1D thermoforming, thermofolding), resistance to cracking for coatings of the invention is apparent. In addition, the coatings of the invention adhere to polymer surfaces to a surprisingly high strength. Moreover, hardness of the coating of the invention meets high automotive hardness standards, proving the surprisingly high hardness of these coatings. Furthermore, the surprisingly high chemical resistance of the coatings of the invention is apparent (acetone test).

An embodiment is the UV curable hard-coat of the invention, which is resistant to cracking upon subjecting onto the UV curable hard-coat an outer fibre strain of a value selected from 1.5% to and including 4%, preferably 2.0%-3.7%, more preferably 2.2%-3.2%, most preferably 2.4%-2.8%, such as 2.5%, when the UV curable hard-coat is coated onto a polymer film such as a polycarbonate film, a polymethyl polymethacrylate (PMMA) film, a co-extruded film such as a co-extruded film comprising polycarbonate and/or PMMA, a multi-layer polymer film such as a composite comprising a layer of polycarbonate and/or comprising a layer of polyethylene terephthalate (PET), and subjected to the outer fibre strain by bending the coated polymer film.

An embodiment is the UV curable hard-coat of the invention, which is resistant to cracking due to elongation of the UV curable hard-coat with a value selected from 1% to and including 20%, preferably 2%-20%, more preferably 3%-20%, most preferably 4%-20%, such as 5%-18%, when the UV curable hard-coat is coated onto a polymer film such as a polycarbonate film, a PMMA film, a co-extruded film such as a co-extruded film comprising polycarbonate and/or PMMA, a multi-layer polymer film such as a composite comprising a layer of polycarbonate and/or comprising a layer of PET, and subjected to the elongation by thermoforming of the coated polymer film.

An embodiment is the method of the invention, wherein the polymer film of step b. is any one of a polycarbonate film, a PMMA film, a co-extruded film such as a co-extruded film comprising polycarbonate and/or comprising PMMA, preferably comprising polycarbonate and PMMA, a multi-layer polymer film such as a composite comprising a layer of polycarbonate and/or comprising a layer of PET, preferably both a layer of polycarbonate and a layer of PET.

An embodiment is the method of the invention, wherein the polymer film is a polycarbonate film which has a thickness of 0.10 mm-0.40 mm, preferably 0.15 mm-0.30 mm, such as 0.25 mm.

An embodiment is the method of the invention, wherein the polymer film is a polycarbonate film which has a thickness of 3 micrometer-100 micrometer, preferably 4 micrometer-50 micrometer, more preferably 5 micrometer-30 micrometer, such as 5 micrometer-10 micrometer. Thus, the method of the invention is suitable for providing polymer one to several hundreds of micrometers thick, as well as for coating a polymer film with a thickness of up to 100 micrometer such as 5-10 micrometer. Exerting outer fibre strain onto the coated polymer or elongation of the coated polymer does not result in cracking of the hard-coat, when the outer fibre strain is 3.7% or less such as 2.5%-3.7% during bending or upon bending, and when the elongation during thermofolding or upon thermoforming is 20% or less such as 1%-20%.

An embodiment is the hard-coated polymer film provided with the UV curable hard-coat according to the invention, wherein the polymer film is any one of a polycarbonate film, a PMMA film, a co-extruded film such as a co-extruded film comprising polycarbonate and/or comprising PMMA, preferably comprising polycarbonate and PMMA, a multi-layer polymer film such as a composite comprising a layer of polycarbonate and/or comprising a layer of PET, preferably both a layer of polycarbonate and a layer of PET, preferably a polycarbonate film.

An embodiment is the hard-coated polymer film provided with the UV curable hard-coat according to the invention, wherein the UV curable hard-coat which is coated onto the polymer film is resistant to cracking upon subjecting onto the hard-coated polymer film an outer fibre strain of a value selected from 1.5% to and including 4%, preferably 2.0%-3.7%, more preferably 2.2%-3.2%, most preferably 2.4%-2.8%, such as 2.5%, wherein the resistance of the UV curable hard-coat to cracking upon subjecting onto the hard-coated polymer film an outer fibre strain is assessed by bending the hard-coated polymer film.

An embodiment is the hard-coated polymer film provided with the UV curable hard-coat according to the invention, wherein the UV curable hard-coat which is coated onto the polymer film is resistant to cracking due to elongation of said polymer film coated with the UV curable hard-coat with a value selected from 1% to and including 20%, preferably 2%-20%, more preferably 3%-20%, most preferably 4%-20%, such as 5%-18%, wherein the resistance of the UV curable hard-coat to cracking due to elongation of said polymer film coated with the UV curable hard-coat is assessed by thermoforming the hard-coated polymer film.

An embodiment is an article or object comprising a polymer film selected from any one of: a polycarbonate film, a PMMA film, a co-extruded film such as a co-extruded film comprising polycarbonate and/or comprising PMMA, preferably comprising polycarbonate and PMMA, a multi-layer polymer film such as a composite comprising a layer of polycarbonate and/or comprising a layer of PET, preferably both a layer of polycarbonate and a layer of PET, the polymer film containing a UV curable hard-coat according to the invention, wherein the article or object is manufactured using moulding such as back moulding, back injection-moulding or in-mould electronics.

The invention is further illustrated by the following examples, which should not be interpreted as limiting the present invention in any way. Modifications and alternative implementations of some parts or elements or compounds are possible, and are included in the scope of protection as defined in the appended claims.

### Examples

### Coating 1

A first hard-coating, or hard-coat, referred to as ‘Coating 1’ for application with polycarbonate film, was prepared by mixing two pre-mixes, A and B.

Pre-mix A consists of the following three components in a 16(:)13(:)55 mass/mass/mass ratio:
1) Undiluted aliphatic urethane tri-acrylate oligomer (Ebecryl 8465 UV/electron beam (EB) energy curable resin; Allnex Group);
2) Hexa-functional aliphatic urethane acrylate oligomer (Ebecryl 5129 UV/EB energy curable resin; Allnex Group);
3) 1-methoxy-2-propanol (Dowanol PM, PubChem SID: 224564957; propylene glycol methyl ether, glycol ether fast evaporating solvent, CAS #107-98-2).

The pre-mix B consists of the following three components in a 0.6(:)0.15(:)15 mass/mass/mass ratio:
a) 1-hydroxycyclohexyl phenyl ketone (SpeedCure 84; Lambson), CAS number 947-19-3, Hansen Solubility Parameters δD (dispersion force interactions) is 19.1, δP (polar force interactions) is 7.2 and δH (hydrogen bond force interactions) is 7.8;
b) Solution of a poly-ether-modified polydimethylsiloxane, a silicone surface additive for solvent-borne coating systems (BYK-300, BYK-Chemie GmbH, Wesel, DE) (density (20° C.) is 0.94 g/ml, non-volatile matter (10 min., 150° C.) is 52%, solvents are xylene and iso-butanol in a 4(:)1 volume/volume ratio, flash point is 23° C.);
c) 1-methoxy-2-propanol.

The Pre-mix A and the pre-mix B were mixed in a mass to mass ratio of 5.4 to 1, therewith providing the Coating 1 of the invention.

As a representative of an aliphatic urethane acrylate oligomer, in the example an aliphatic urethane tri-acrylate oligomer was implied in the UV curable hard-coat according to the invention.

Application of the Coating 1 of the invention was by applying the Coating 1 onto Makrofol DE 1-1 polycarbonate film (Covestro, Pittsburgh, Pa., USA), an extrusion film based on Makrolon polycarbonate (Covestro). The PC film had a thickness of 0.25 mm. The PC film was highly transparent suitable for optical applications. Recommended applications for the PC film are in automotive, labels, membrane switches, nameplates and thermoforming packaging, according to the manufacturer. The typical properties of the PC film implied in the current example are displayed in the Table 1 below, as provided by the manufacturer (datasheet dated 8 Mar. 2012).

TABLE 1
Properties of Makrofol DE 1-1 PC film
(taken from datasheet dated 8 Mar. 2012)

| Property | Test Method | Unit | Value |
|---|---|---|---|
| Specific Gravity | ASTM D 792 | | 1.20 |
| Conversion Factor | | ft²/lb · mil \| m²/kg · | |
| | | mm 161 \| 0-833 | |
| Gloss 60° top side | ASTM D 2457 | gloss unit | >90 |
| black inked second surface | | | |
| Gloss 60° reverse side | ASTM D 2457 | gloss unit | >90 |
| Roughness, R3z, top side | ISO 4287/88 | mm | <0.5 |
| Roughness, R3z, reverse side | ISO 4287/88 | mm | <0.5 |
| Surface | | | gloss/gloss |
| Mechanical | | | |
| Tensile Strength, Yield | ASTM D 882 | psi | 9,100 |
| Tensile Strength, Break | ASTM D 882 | psi | 10,500 |
| Elongation at Break | ASTM D 882 | % | 125 |
| Flexural Modulus | ASTM D 790 | psi | 330,000 |
| Tear Strength, Initiation | ASTM D 1004 | lb/in | 1,100 |
| Thermal | | | |
| Coefficient of linear thermal | DIN 53752 | 10(−6)/K | 70 |
| expansion parallel 20° C. | | | |
| to 120° C. | | | |
| Coefficient of linear thermal | DIN 53752 | 10(−6)/K | 70 |
| expansion across 20° C. | | | |
| to 120° C. | | | |
| Shrinkage, parallel | IEC 60674-2 | % | <0.4 |
| 130° C., 1 h | | | |
| Shrinkage, across | IEC 60674-2 | % | <0.4 |
| 130° C., 1 h | | | |
| Heat Deflection Temperature | ASTM D 648 | ° F. | |
| 1.82 MPa | | | 270 |
| 0.45 MPa | | | 288 |
| Vicat Softening Temperature, | ASTM D 1525 | ° F. | 297 |
| Rate A | | | |
| Flammability | | | |
| Burning Rate (FMVSS 302) | ISO 3795 | mm/min | <100 |
| UL Listing | UL 94 V-2 | min. thickness | |
| | | 0.015″ (375 pm) | |
| UL Listing | UL 94 VTM-2 | min. thickness | |
| | | 0.005″ (125 pm) | |
| Optical | | | |
| Haze | ASTM D 1003 | % | <1 |
| Light Transmittance | ASTM D 1003 | % | 89 |
| Yellowness Index | ASTM E 313 | | 1 |
| Other | | | |
| Water Absorption (saturation) | ISO 62 | % | 0.20 |
| Water Absorption (immersion | ASTM D 570 | % | 0.35 |
| at 73° F./24 h) | | | |

The Coating 1 of the invention is applied onto the Makrofol DE 1-1 PC film using conventional slot die coating technique known to the skilled person. After coating of the PC film with the Coating 1 of the invention, the coated PC film was cured with a standard mercury H-bulb known in the art (Fusion 558412 H; Heraeus—Uvio (Berkshire, UK). The exposure to UV radiation was measured and controlled using a Powerpuck device (EIT), with the energies as tabulated in Table 2. Noteworthy, the PC film coated with the Coating 1 of the invention does not require a second UV curing step after forming of the PC film into a desired form or shape, unlike the hard-coated PC film XtraForm (MacDermid Enthotone), which requires a second UV curing step after forming of the film, in order to meet the stringent industry quality standards with regard to e.g. chemical resistance, hardness.

TABLE 2
Powerpuck energies

| UVA | | UVB | | UVC | | UVV |
|---|---|---|---|---|---|---|
| mJ/cm² | mW/cm² | mJ/cm² | mW/cm² | mJ/cm² | mW/cm² | mJ/cm² |
| 648 | 304 | 579 | 280 | 174 | 84 | 490 |

After the curing, the hard-coated PC film coated with the hard-coat Coating 1 of the invention was compared for a series of properties side by side in the same series of experiments with the XtraForm hard-coated PC film (MacDerwind Enthone) as outlined here below. The PC film coated with the hard-coat of the invention was tested for delta haze after taber abrasion test, adhesion after ageing, formability in a Niebling HPF forming process, hardness in a pencil test and chemical resistance upon exposure to acetone.

### Coating 2

A second hard-coating, or hard-coat of the invention, referred to as ‘Coating 2’ for application with polycarbonate film, was prepared by mixing the following five components in a ratio of 45.2(:)37.0(:)25.0(:)1.07(:)0.15 mass/mass/mass/mass/mass.
1) Undiluted aliphatic urethane tri-acrylate oligomer (Ebecryl 8465 UV/electron beam (EB) energy curable resin; Allnex Group);
2) Hexa-functional aliphatic urethane acrylate oligomer (Ebecryl 5129 UV/EB energy curable resin; Allnex Group);
3) 1,6-hexanediol di-acrylate (clear, yellow liquid, HDDA; PubChem CID: 25644; alternative chemical name: 13048-33-4 or hexa-methylene di-acrylate; IUPAC name: 6-prop-2-enoyloxyhexyl prop-2-enoate);
4) Photo-initiator for radical polymerization of unsaturated resins upon UV light exposure, bis(2,4,6-trimethylbenzoyl)-phenyl-phosphine oxide, molecular weight 418.5 g/mol (Ciba IRGACURE 819 Photo-initiator; Ciba Specialty Chemicals, Inc.);
5) Solution of a poly-ether-modified polydimethylsiloxane, a silicone surface additive for solvent-borne coating systems (BYK-300, BYK-Chemie GmbH, Wesel, DE) (density (20° C.) is 0.94 g/ml, non-volatile matter (10 min., 150° C.) is 52%, solvents are xylene and iso-butanol in a 4(:)1 volume/volume ratio, flash point is 23° C.).

The mixed five components in the indicated mass ratio provided the Coating 2 of the invention. The viscosity of the solid coating is very high (the Coating 2 consists of 100% solids at room temperature, and solvents are not implied in the coating composition).

Application of the Coating 2 of the invention was by applying the Coating 2 onto Makrofol DE 1-1 polycarbonate film (Covestro, Pittsburgh, Pa., USA), an extrusion film based on Makrolon polycarbonate (Covestro), and the same as applied for the test with Coating 1, outlined here above. The PC film had a thickness of 0.25 mm. The typical properties of the PC film implied in the current example are displayed in the Table 1 above.

The Coating 2 of the invention is applied onto the Makrofol DE 1-1 PC film using conventional film coating technique known to the skilled person, i.e. dispensing technique. After film coating of the PC film with the Coating 2 of the invention, the coated PC film was cured in a single UV curing step with a UV LED of 395 nm unit (4Pico, Sint-Oedenrode, NL). The curing speed was 0.37 m/min. For inducing adhesion of Coating 2 onto the PC film surface before the curing step, the coated PC film was heated at 50° C. Noteworthy, like Coating 1, the PC film coated with the Coating 2 of the invention does not require a second UV curing step after forming of the PC film into a desired form or shape, unlike the hard-coated PC film XtraForm (MacDermid Enthotone), which requires a second UV curing step after forming of the film.

After the single curing step, the hard-coated PC film coated with the hard-coat Coating 2 of the invention was compared for a series of properties side by side in the same series of experiments with the XtraForm hard-coated PC film (MacDerwind Enthone) as outlined here below. The PC film coated with the hard-coat Coating 2 of the invention was tested for delta haze after taber abrasion test, adhesion after ageing, formability in a Niebling HPF forming process, hardness in a pencil test and chemical resistance upon exposure to acetone.

Noteworthy, the Coating 2 of the invention is also UV curable when applied onto the PC film using film coating, using a 395-nm UV LED.

### Comparative Example

The hard-coated polycarbonate film ‘XtraForm’ (MacDermid Enthone, Oxfordshire, UK) was included in the tests for i) delta haze after 100 cycles of taber abrasion (ASTM D1044—13), ii) adhesion after VW TL226 ageing (DIN 53151:1981-05), iii) formability on positive mould (Niebling HPF forming process), and iv) chemical resistance. See the Example section parts here below, for the comparative test results.

XtraForm is promoted as a hard-coated PC film with superior performance in deep forming process, when applied in a medium form process, shallow form applications. The XtraForm as good performance in a pencil hardness test, according to the manufacturer. Scratch resistance or abrasion resistance is also superior, as is the chemical resistance or solvent resistance, according to the manufacturer.

Typically, according to the manufacturer, the XtraForm hard-coated PC film is suitable for screen printing, subsequent forming (optional), and requires UV curing after printing on the PC sheet, or after printing on the PC sheet followed by forming. The UV-cured (formed) PC sheet can then be subjected to cutting and injection moulding applications, providing an in-mould decorated (and formed) hard-coated PC film.

According to the manufacturer, the hard-coated PC film XtraForm is suitable for applications such as HVAC control systems, radio panels, control panels. The hard-coated PC film is suitable for film insert moulding in general. For automotive applications, the scratch resistance and chemical resistance are beneficial characteristics. Indicated applications for the automotive industry are instrument clusters, HVAC's, radio bezels, touch screens, touch panels, PRNDL and trims, according to MacDermid Enthone. For telecom applications, in-mould labelling for lenses, housing and keypads are mentioned, as well as outer casings of mobile phones, as examples of suitable use of the XtraForm hard-coated PC film. For appliance purposes, e.g. flat or formed control panels for e.g. domestic appliance applications are mentioned as suitable uses for the XtraForm film.

### Hardness Test of Coats/Coating—Taber Abrasion

The hardness of the coatings Coating 1 and Coating 2 of the invention was assessed in a taber abrasion test according to the ASTM D1044 standard as in force in Q2-2019 (version ASTM D1044-13). The hardness was compared to the XtraFrom coated OC film. The taber abrasion is a test to determine a plastids resistance to abrasion. Resistance to abrasion is defined as the ability of a material to withstand mechanical action such as rubbing, scraping, or erosion. Before subjecting coated film specimens to the taber abrasion test, the haze is measured. After subjecting the specimens to the taber abrasion test, the haze is again measured. Results of the test with a coated film are expressed by changes in % haze after the indicated number of test cycles (‘Delta haze’).

The coats Coating 1 and Coating 2 of the invention presented with a Delta haze of 8.1% after 100 cycles of taber abrasion in the taber abrasion test executed according to ASTM D1044-13. In a comparative test with the XtraForm hard-coated polycarbonate film (MacDermid Enthone, Oxfordshire, UK), the test revealed that the taber abrasion for this standard hard-coated PC film known in the art was 9.2%.

### Hardness Test of Coats/Coating—Pencil Test

The hardness of the coatings of the invention was assessed in a pencil test according to the ASTM D3363 standard as in force in Q2-2019 (version ASTM D3363-5(2011)e2). The hardness was compared to the XtraFrom coated OC film. Determination of the coated PC film hardness, i.e. the hardness of a coating on a substrate, involves the use of pencil leads of known hardness.

The coat of the invention Coating 1 and Coating 2 presented with a pencil hardness similar if not equivalent to the pencil hardness of the XtraForm hard-coated PC film of MacDermid Enthone.

Chemical Resistance Test with Coats/Coatings

The chemical resistance of the coatings Coating 1, Coating 2 and comparative example XtraForm was assessed by determining the effect of exposure of a coat to liquid acetone. To this end, a coat applied onto a plastic film as a carrier of the coat, was provided with a cavity in the exposed top surface of the coat. Acetone was applied into the formed cavity and left for ten minutes at room temperature. After ten minutes, the acetone was removed and the effect of contacting the coat surface with acetone was assessed as a measure of chemical resistance of the coat.

The coats Coating 1 and Coating 2 of the invention expressed high chemical resistance, better than what was observed for the XtraForm coated PC film, since none of the two manufactured coats Coating 1 and Coating 2 as outlined in the Examples section here above, experienced any chemical decay or effects of exposure to the acetone. That is to say, after exposure of the coats according to the invention to the acetone, no detectable change was apparent, there was not any slight change in color or gloss apparent, not even a slight surface etching or severe staining was apparent, and not any of pitting, cratering, swelling or erosion of coating was apparent, and in addition none of obvious and significant deterioration was observed. In contrast, for the XtraForm coated PC film it was obvious that the coated surface was less stable. An opaque surface with opalescent spots was observed for the XtraForm exposed to the acetone in the chemical resistance test. No sign of damage to the Coating 1 or Coating 2 when applied to the PC film, was observed after exposure to the acetone.

Formability Test with Coatings

Polycarbonate films provided with the Coating 1 or the Coating 2 of the invention were tested for their applicability in thermoforming applications, when these films were provided with a coat Coating 1 or Coating 2 of the invention. Comparison was made to the formability of the XtraForm hard-coated PC film. To this end, PC films were provided with a coat of the invention, and after UV curing of the coat as here above described, the coated films were subjected to thermo-folding procedures known in the art. The applied process for forming the coated plastic films was the so-called “Niebling process”. Note: the XtraForm PC film required a second UV curing step, which was not required for the coatings Coating 1 and Coating 2 of the invention.

### The Niebling Process for the Forming of Plastic Films

The so-called Niebling process is for the isostatic High Pressure Forming (HPF) of plastics. This “Niebling process” is applied for processing plastic films and other thin-layer materials. In brief, the Niebling process is described as follows (source: website of niebling Formtechnologie, Penzberg, DE). The heart of the Niebling process is a non-contact heating system. It comprises heating modules with individual heating elements; the temperatures of the elements are specifically adjusted. In this way a distinct temperature profile can be produced depending on the material and forming task. During this process, unlike during thermoforming, the substrate is only heated to the “glass transition temperature” (e.g. polycarbonate: approx. 148° C.), as result the material can be formed, but it is not melted. Once placed in the form, the heated material is then formed using compressed air (forming pressures up to 300 bar). The result: low material stretching and minimal position tolerances for graphic motifs (depending on material and geometry 0.3 mm). At the same time, cycle times of 10 sec. to 15 sec. are achievable. The heating system interacts with a continuously pressure profile controller.

For the Makrofol DE 1-1 PC film coated with Coating 1 or Coating 2 of the invention, and for the XtraForm hard-coated PC (comparative example), the formability was tested on a positive mould moulding set-up at an angle of 95° in a Niebling HPF forming process (forming temperature was 180° C.).

### Characteristics of Applying the Niebling Process of “Isostatic” High Pressure Forming:

Low material stretching
Highest precision during the positioning of graphic motifs combined with reliable repeatability of the forming result
Retention of gloss levels, surface structures and surface feel (e.g. on matt or textured films)
Suitable for relatively large formats (up to 1,000 mm×500 mm; forming height: up to 300 mm) and larger material thicknesses (up to 12 mm for polycarbonate)
Suitable for amongst other materials, PC
Excellently suited to the forming of films with chemically-resistant and scratch-resistant surfaces.

### Results of Forming the Coated PC Films

All coated films tested, i.e. Makrofol DE 1-1 film provided with a hard-coating Coating 1 of the invention, or provided with a hard-coating Coating 2 of the invention, or XtraForm hard-coated PC presented as formed films after applying the coated films to the Niebling process of plastic film forming, with good quality. That is to say, the coat on the films showed no signs of any cracking, de-colouring, stress-induced deformations, haze, non-homogenous coating layer thickness, etc., that otherwise would indicate the incompatibility of the coats of the invention with the forming process applied. Therefore, the coats of the invention, when applied onto films or sheets of materials such as PC, is highly compatible with film forming, for example by applying a forming process such as the Niebling process. Since the forming of the coated films deformed the coated films without any signs of stress-induced changes, it is demonstrated that the coats of the invention are capable of local deformation and thinning without structural alterations or changes affecting the quality of the coat. Thus, the coat of the invention, when applied onto a plastic film such as a film of PC, is formable and can be subjected to local thinning in portions of the surface area of the coated film, without drawbacks when the coat quality is assessed. Coat hardness and coat chemical resistance are excellent, as is the formability including resistance to (local) coat damage by thinning.

Based on the coated film formability test results, it is thus concluded that the coated films of the invention provides a flexible hard coated film, which presents as a durable film when the chemical resistance is concerned. No taber haze was apparent with the coats applied for the coated films tested. Due to the high hardness of the coat (see here above; taber abrasion of 8 after 100 cycles) and due to the good chemical resistance (survived acetone test without any sign of an effect of the exposure to the acetone), typically the hard-coated films are applicable for use as e.g. overlays and injection moulded decoration face plates applied in e.g. automotive.

For Coating 1 of the invention, the test results are summarized in Table 3 and compared to the test results obtained with the comparative example XtraForm (MacDermid Enthone).

TABLE 3
Quality assessment of Coating 1 when coated onto PC film

| | | Adhesion (DIN | Formability on | |
|---|---|---|---|---|
| | Delta haze | 53151) | positive mould | |
| | (%) after 100 | after VW | with 95° angle | Chemical |
| | cycles Taber | TL226 ageing | in Niebling HPF | resistance |
| | abrasion | (72 hours 90° C. | forming process | (10 minutes |
| | (ASTM | at 90% relative | (forming temp: | contact with |
| Product | D1044) | humidity) | 180° C.) | acetone) |
| Coating 1 | 8.1 | OK | OK | OK |
| XtraForm | 9.2 | OK | OK | OK |

For Coating 2 of the invention, the test results are summarized in Table 4 and compared to the test results obtained with the comparative example XtraForm (MacDermid Enthone).

TABLE 4
Quality assessment Coating 2 when coated onto PC film

| | | | Formability on |
|---|---|---|---|
| | | | positive mould |
| | Delta haze (%) | | with 95° angle |
| | after 100 | Adhesion (DIN | in Niebling HPF |
| | cycles | 53151) after applying | forming process |
| | Taber abrasion | the coat onto the | (forming |
| Product | (ASTM D1044) | PC film | temp: 180° C.) |
| Coating 2 | 8.1 | OK, GT0 | OK |
| XtraForm | 9.2 | OK | OK |

Thus, the PC films coated with the hard-coats Coating 1 or Coating 2 had a high hardness comparable to the commonly applied XtraForm hard-coated PC film known in the art, whereas the Coating 1 and Coating 2 only required a single UV hardening step directly after applying the coating onto the PC film in order to arrive at this desired high hardness. In contrast, the XtraForm PC film needed a first UV curing step directly after applying the coating onto the PC film, similar to Coating 1 and Coating 2 coated onto PC film, and in addition a second UV curing step after the forming of the coated PC film in the Niebling HPF forming process, in order to be able to arrive at the desired hardness. Formability of the Coating 1 and the Coating 2 of the invention is equally good as the formability of the XtraForm hard-coated PC film known in the art.

Similar to the XtraForm hard-coated PC film, the PC film coated with the Coating 1 of the invention or the Coating 2 of the invention met the Volkswagen criteria with regard to hardness. Similarly, hardness criteria according to the Mercedes criteria and the Ford criteria are thus also met with the hard-coated PC films of the invention. The XtraForm hard-coated PC films require an additional second UV curing step after the forming in order to meet the required hardness criteria set by Volkswagen, Ford, Mercedes, etc., whereas the Coating 1 and the Coating 2 of the invention are already meeting these hardness criteria when applied onto PC film and subsequently formed, when only subjected to a single brief UV curing step after applying the coatings onto the PC films using either slot die coating, or coat dispensing technique (using film coating). Since the Coating 1 and the Coating 2, once applied onto a PC surface, do not require a second UV curing step after forming the hard-coated PC film, the hard-coated PC film does not have to be handled in UV safe conditions at every process stage until the forming of the film has been established and thereafter. This in contrast to the UV safe handling conditions that are a prerequisite for processing of e.g. XtraForm hard-coated PC films up to and after forming of the film, and up to the establishment and finishing of the second mandatory UV curing step after the PC film has been formed.

### Comparative Examples

As said, International patent application WO 2018/121613 A1 (Applicant: PPG COATINGS (TIANJIN) CO., LTD. (China), relates to a UV curable coating composition comprises a high-functionality UV curable polyurethane acrylate (functionality is 10 in embodiments). Typically, the coating composition of WO 2018/121613 A1 comprises butyl acetate and isobutyl acetate.

The UV curable hard-coats of the invention are subjected to quality tests side by side together with various UV curable hard-coats according to WO 2018/121613 A1 in comparative tests, in order to assess differences in quality measures such as thermoformbility of a coating on a polymer surface, and in order to be able to demonstrate the surprising improvements achieved by the inventors when for example anti-cracking behaviour is compared under influence of thermoforming (1D, 3D).

That is to say, the coating compositions according to WO 2018/121613 A1 do not provide coatings that can be thermoformed without resulting in severely cracked coating layer, whereas in contrast, the coatings of the invention are thermoformable, providing non-cracked and clear coatings, even when elongated up to 20% (high-pressure 3D thermoforming conditions; temperature during thermoforming was 150° C.-160° C.) and when an outer fibre strain of up to 3.7% is applied on the coated surface. Indeed, the coatings of the invention are thermoformable under conditions resulting in an elongation of larger than 0% and up to 20%, such as between >1% and <20%, >5%-<19%, or from and including 0.5% up to and including 18%. Within these thermoforming limits, no cracking of the coating of the invention is observed for example coatings. In stark contrast, coatings according to WO 2018/121613 A1 already show severe cracking when similarly 3D thermofolded (thermoformed) up to an elongation of as little as 0.5% or less. The coatings obtained from the coating compositions according to WO 2018/121613 A1 already show severe cracking when an outer fibre strain of 2.5% is applied to the coatings at temperatures above the glass transition temperature of the polycarbonate on which the comparative coating was provided (at this temperature the polycarbonate becomes visco-elastic). In contrast, and to the surprise of the inventions, the coatings obtained with the method of the invention using the coating compositions of the invention do not show cracking when an outer fibre strain of 2.5% is applied to the coatings at temperatures above the glass transition temperature of the polycarbonate on which the comparative coating was provided.

These comparisons altogether demonstrate that the coatings of the invention have a surprisingly high thermoformability (thermofoldability) before cracking of the coating becomes apparent. Even when elongated up to 20% (3D thermoforming), the coating of the invention does not crack and remains transparent, and even when an outer fibre strain of 2.5%-3.7% is exerted onto the coating (1D thermoforming, thermofolding), resistance to cracking for coatings of the invention is apparent. In addition, the coatings of the invention adhere to polymer surfaces to a surprisingly high strength. Moreover, hardness of the coating of the invention meets high automotive hardness standards, proving the surprisingly high hardness of these coatings. Furthermore, the surprisingly high chemical resistance of the coatings of the invention is apparent (acetone test).

TABLE 5
Coatinq compositions accordinq to the Examples section of WO 2018/121613 A1

| | | | Molecular | | | | |
|---|---|---|---|---|---|---|---|
| | | | weight | | Composition wt % | | |
| compound | Reference | Supplier | (g/mol) | Functionality | Ex 1 | Ex 2 | Ex3 |
| Polyurethane | EB5129 | allnex | 800-4000 | 6 | 10 | 30 | 50 |
| acrylate oligomer | | | | | | | |
| (1) | | | | | | | |
| Polyurethane | EB225 | allnex | | 10 | 50 | 30 | 10 |
| oligomer (2) | | | | | | | |
| Solvent (1) | BuAc/IBuAc 50/50 | | N/A | 0 | 37 | 37 | 37 |
| Photoinitiator | Speedcure 84 | Lambson | N/A | 0 | 2.5 | 2.5 | 2.5 |

‘BuAc’ is butyl-acetate; ‘IBuAc’ is isobutyl-acetate; ‘EB 5129’ is Ebecryl 5129 hexafunctional aliphatic urethane acrylate oligomer (allnex, datasheet February 2017); ‘EB 225’ is Ebecryl 225 ten functional aliphatic urethane acrylate (allnex, datasheet May 2018); ‘EB 8465’ is Ebecryl 8465 undiluted aliphatic urethane triacrylate oligomer (allnex, datasheet February 2017); wt % is percentage by weight.

TABLE 6
Coating compositions according to the current invention.

| | | | Molecular | | | | |
|---|---|---|---|---|---|---|---|
| | | | weight | | Composition wt % | | |
| compound | Reference | Supplier | (g/mol) | Functionality | IP1 | IP2 | IP3 |
| Polyurethane | EB5129 | allnex | 800-4000 | 6 | 27 | 51 | 36 |
| acrylate oligomer | | | | | | | |
| (1) | | | | | | | |
| Polyurethane | EB8465 | allnex | | 3 | 33 | 9 | 24 |
| oligomer (3) | | | | | | | |
| Solvent (2) | EB/IPA 50/50 | | | 0 | 37 | 37 | 37 |
| Photoinitiator | Speedcure 84 | Lambson | N/A | 0 | 2.5 | 2.5 | 2.5 |

‘EB’ is ethylene glycol monobutyl ether; ‘IPA’ is isopropanol. See for other abbreviations and definitions Table 6.

TABLE 7
Film characteristics of polymer films coated with comparative
coating compositions and with coating compositions according to
the invention. Coating steps relating to curing are also listed.
Film thickness 5-10 micrometer
UV400-1600 Mj/cm², 80-300 Mw/cm²
(UV lamp)
Substrates tested: PMMA, PC, PET
Coating compositions according to
Table 5, 6 and 9 are diluted with EtAc, or
the 50%-50% mixture of IPA/EB, as
indicated
After dilution of coating compositions,
viscosity was 7.5-8.5 s (IWATA 2# flow
cup for determining flow time): ASTM
D1200-94
Procure at 60° C.-80° C. for 5-10 minutes,
as indicated, before UV curing is applied
UV curing step after a procure step, as
indicated
‘EtAc’ is ethyl acetate

In the comparative tests, coatings EX1, EX2 and EX3 according to WO 2018/121613 A1 were compared side by side in experiments together with coatings IP1, IP2 and IP3 according to embodiments of the invention (See Table 5, Table 6). In several tests, the substrate onto which the coating compositions (diluted according to Table 7, further coating details in Table 10) were applied was a polycarbonate (PC) film. After applying the diluted coating composition, the coating is covered with a foil (UV transparent foil, a heat-stabilized poly-ester film of high optical quality). Then, the coating is procured and cured (Table 7). The coated films were subjected to quality tests according to Table 8.

TABLE 8
Assessment of parameter values for polymer sheets coated
with comparative coatings according to WO 2018/
121613 A1 and with coatings according to the invention.
Tests performed with coated surfaces
Pencil hardness (ASTM D3363-
05(2011)e2)
Wire wool scratch test
Cross-hatch adhesion test (ISO
2409:2013)
contact angle
Light transmission
Taber 100 (ASTM d1044, cs10f wheels)
(ASTM D1044-13)
Chemical resistance against acetone
Formability

TABLE 9
Overview of three coating compositions according to WO 2018/121613 A1
and of three coating compositions according to the current invention.

| | | Composition wt % | | | | | |
|---|---|---|---|---|---|---|---|
| Reference | Supplier | Ex1 | Ex2 | Ex3 | IP1 | IP2 | IP3 |
| EB 5129 | allnex | 10 | 30 | 50 | 27 | 51 | 36 |
| EB 225 | allnex | 50 | 30 | 10 | 0 | 0 | 0 |
| EB 8465 | allnex | | | | 33 | 9 | 24 |
| BuAc/IBuAc 50/50 | | 37 | 37 | 37 | 0 | 0 | 0 |
| PM | | 0 | 0 | 0 | 37 | 37 | 37 |
| Speedcure 84 | Lambson | 2.5 | 2.5 | 2.5 | 2.5 | 2.5 | 2.5 |
| % solids based on the | | 62.8 | 62.8 | 62.8 | 62.8 | 62.8 | 62.8 |
| total weight of the | | | | | | | |
| coating composition | | | | | | | |

‘PM’ is 1-methoxy-2-propanol (Dowanol PM)

TABLE 10
Scheme for preparing flow-coating solutions based on the
coating solutions outlined in Table 5. 6 and 9.
Pre-preparation for flow coating

| | 150% solvent for dilution added to coating |
|---|---|
| | compositions EX1, EX2, EX3, IP1, IP2 and IP3; |
| Dilution | 40 wt % coating composition + 60 wt % IPA/ |
| IPA/EB | EB → 25 wt % solids in the flow-coating solution |
| Application | Flow coat |
| Flash off | 10 minutes |
| Precure | 10 minutes at 70° C. |
| UV cure | lab UV at setting 18 (365 nm) |

Flow coating: the sheet or film is hung vertically and the coating is poured onto the surface from the bottom left hand side, up to the top left hand side across the top and then down from the top right hand side to the bottom right hand side—or vice versa. The coating flows down the panel to produce a continuous film which drains from top to bottom until the solvents evaporate (during the flash off time). Flash-off: after applying the coating composition (Table 7, Table 9, diluted coating compositions), solvents are evaporated from the coatings. All coatings tested in the comparative examples are made in a single run of preparing coated PC surfaces (see Table 11). UV cure: The sheet receives a total of 1000-2000 mj/cm² UV radiation as measured in the UVA segment of the lamps UV output.

TABLE 11
Coating conditions, sequential coating steps for comparative
examples and for coatings according to embodiments of the invention.
Application timings (sequential in one run, times in minutes)

| | | Oven | |
|---|---|---|---|
| Sample reference | Coated | (procure) | UV curing |
| EX1 | 0 | 10 | 20 |
| EX2 | 3 | 13 | 23 |
| EX3 | 6 | 16 | 26 |
| IP1 | 9 | 19 | 29 |
| IP2 | 12 | 22 | 32 |
| IP3 | 15 | 25 | 35 |

Explanation: in one test run sample EX1 was UV cured after 20 minutes from the start of the test, and final sample IP3 was provided after the UV curing step at 35 minutes from the start of the test.

All tested coating layers were clear and transparent after the UV curing step.

Coated PC samples were subjected to the 1D outer fibre strain test as outlined in Table 12. Coated PC sheets of about 10 cm×10 cm were thermoformed at the indicated temperature and up to the indicated outer fibre strain. Extent of cracking was assessed according to the indicated rating and scale. Coatings according to the prior art did not resist the outer fibre strain of 2.5%: heavy cracks. In contrast, coatings according to the invention can resist outer fibre strain of 2.5% and even up to 3.7%.

TABLE 12
Results of resistance-to-cracking test with coated polymer films
and results of cross-hatch test after soaking of
coated polymer films in water.

| | Forming 7 minutes | | cross-hatch test results after | |
|---|---|---|---|---|
| | | | water soak, 65° C., film is | |
| | at 160° C. | | immersed in the water bath (days) | |
| Sample | | OFS | Day 0 (before | |
| reference | OFS 2.5% | 3.7% | immersing in water) | Day 7 |
| EX1 | 0 | 0 | GT0 | GT0 |
| EX2 | 0 | 0 | GT0 | GT0 |
| EX3 | 0 | 0 | GT0 | GT0 |
| IP1 | 5 | 5 | GT0 | GT0 |
| IP2 | 3 | 0 | GT0 | GT0 |
| IP3 | 5 | 2 | GT0 | GT0 |

‘OFS’ is outer fiber strain
Forming evaluation visual rating: 5 = no cracks,
3 = fine cracks,
0 heavy cracks.

The resistance to cracking of the applied hard-coats is assessed by subjecting the coated polymer film to an OFS after the material is brought above its glass transition temperature. Test results are provided in Table 12 for the polycarbonate film, which was thermoformed for 7 minutes at 160° C., which thermoforming temperature is above the glass transition temperature of the polymer film, such that the polycarbonate is visco-elastic.

Cross-hatch (X-Hatch) testing revealed that the coatings scored GTO after 7 days of soaking in water, i.e. the same score as before subjecting the films to the test. Testing according to DIN ISO NF 2409; score GTO reflects the best result, with no removal, a score of GTS: worst significant removal after tape pull off.

TABLE 13
Results of the taber abrasion test with comparative example polymer films provided with
coatings according to the prior art WO 2018/121613 A1 (Table 5, Table 9) or with coatings
of the invention (Table 6, Table 9). The exemplifying polymer sheet is the polycarbonate
film. Chemical resistance test by soaking of coated polymer film in acetone.

| | Taber abrasion 100 cycles (ASTM D0144-13) | | | | | |
|---|---|---|---|---|---|---|
| | | | | | Light | Chemical |
| | | | | | transmittance | Resistance |
| | Initial Haze | 100 Haze | | | before taber | after exposure |
| Sample | at the start of | (haze after | | C Thickness | abrasion test | for 10 minutes |
| reference | the test | 100 cycles) | Δ haze | (micrometer) | [%] | Acetone |
| EX1 | 0.14 | 4.28 | 4.14 | 7.5 | 89.1 | ok |
| EX2 | 0.15 | 4.4 | 4.25 | 6.5 | 89.9 | ok |
| EX3 | 0.14 | 4.3 | 4.16 | 6.7 | 89.3 | ok |
| IP1 | 0.15 | 8.03 | 7.88 | 7.9 | 89.8 | ok |
| IP2 | 0.23 | 6.07 | 5.84 | 7.1 | 88.9 | ok |
| IP3 | 0.16 | 7.88 | 7.72 | 8.3 | 89 | ok |

For chemical resistance testing, an absorbant cloth is placed on the test sample (coated polymer film) and soaked with the solvent (here acetone) and additional solvent (acetone) is added if the cloth becomes dry due to evaporation. After the 10 minutes, the cloth is removed and remaining solvent wiped with an absorbant cloth, and the coated film is examined for attach/haze and general degradation of the surface.

The results of the taber abrasion test and the chemical resistance test (Table 13) revealed that the coatings of the invention are highly resistant against wear and are highly chemically resistant.

An important and main conclusion from the comparisons made between the coatings according to WO 2018/121613 A1 and coatings according to embodiments of the invention is that the invention provides hard and transparent and chemically resistant coatings that are resistant to cracking when thermofolded (thermoformed), whereas coatings according to WO 2018/121613 A1 are not.

### Examples: Hard-Coated Polymer Films

The inventors established that the UV-curable hard coatings of the invention equally and strongly adhere to a variety of different types of polymer films and film materials such as polycarbonate films, PMMA films, co-extruded films such as a co-extruded film comprising polycarbonate and PMMA, multi-layer polymer films such as a composite comprising a layer of polycarbonate and a layer of PET. Polymer films or sheets of these materials or combination of materials were hard-coated with the UV curable hard-coat of the invention by applying the method of the invention, similar to the coating of the PC films as outlined in the comparative examples here above. Testing the firmness of the adhesion of the coated hard-coat of the invention onto these types of films revealed that the hard-coat of the invention was coated similarly strong or equally strong on the surfaces of these further types of polymer film, when compared to the coating strength and strong binding of the coating when the hard-coat of the invention is coated onto a polycarbonate film. Thus, to the surprise of the inventors, the UV-curable hard-coat of the invention is suitable for coating a wide variety of different polymer film surfaces. Herewith, the invention provides a universal hard-coat for providing a widespread scope of different polymer films with a strong and chemically resistant hard-coat that is resistant to cracking when subjected to elongation by thermofolding and that is resistant to cracking when subjected to outer fibre strain.

1. A UV curable hard-coat for a polymer film, the UV curable hard-coat comprising
a. aliphatic urethane acrylate oligomer;
b. hexa-functional aliphatic urethane acrylate oligomer;
c. a photo-initiator; and
d. an organic solvent.

2.-3. (canceled)

4. The UV curable hard-coat of claim 1, wherein the organic solvent is any one of: 2-methoxyethanol, 2-ethoxyethanol, 2-propoxyethanol, 2-isopropoxyethanol, 2-butoxyethanol, 2-phenoxyethanol, 2-benzyloxyethanol, 1-methoxy-2-propanol, 2-(2-methoxyethoxy)ethanol, 2-(2-ethoxyethoxy)ethanol, 2-(2-butoxyethoxy)ethanol, di-propyleneglycol methyl ether, or a combination thereof.

5.-6. (canceled)

7. The UV curable hard-coat of claim 1, further comprising a flow modifier, wherein the flow modifier is poly-ether-modified polydimethylsiloxane or wherein the flow modifier is poly-ether-modified polydimethylsiloxane dissolved in xylene and iso-butanol at a 4(:)1 volume/volume ratio.

8.-10. (canceled)

11. The UV curable hard-coat of claim 1, wherein the aliphatic urethane acrylate oligomer is a tri-functional polyurethane oligomer.

12.-16. (canceled)

17. The UV curable hard-coat of claim 1, further comprising a flow modifier, wherein the flow modifier is present in an amount of 0.016%-0.064% based on the total mass of the UV curable hard-coat, preferably 0.020%-0.050%, more preferably 0.024%-0.045%, most preferably 0.028%-0.040%, such as 0.030%-0.035% or 0.031%-0.033%; wherein the flow modifier is present in an amount of 0.04%-0.30% based on the total mass of the UV curable hard-coat.

18. (canceled)

19. The UV curable hard-coat of claim 1, wherein the organic solvent is 1-methoxy-2-propanol and wherein the organic solvent is present in an amount of 33.0%-84.0% based on the total mass of the UV curable hard-coat, preferably 60.0%-75.0%, more preferably 63.0%-72.0%, most preferably 65.0%-70.0%; or wherein the organic solvent is—methoxy-2-propanol or any one of: 2-methoxyethanol, 2-ethoxyethanol, 2-propoxyethanol, 2-isopropoxyethanol, 2-butoxyethanol, 2-phenoxyethanol, 2-benzyloxyethanol, 1-methoxy-2-propanol, 2-(2-methoxyethoxy)ethanol, 2-(2-ethoxyethoxy)ethanol, 2-(2-butoxyethoxy)ethanol, di-propyleneglycol methyl ether, or a combination thereof, and wherein the organic solvent is present in an amount of 20.0%-70.0% based on the total mass of the UV curable hard-coat.

20.-21. (canceled)

22. The UV curable hard-coat according to claim 1, wherein the photo-initiator is bis(2,4,6-trimethylbenzoyl)-phenyl-phosphine oxide and the organic solvent is 1,6-hexanediol diacrylate.

23. (canceled)

24. The UV curable hard-coat of claim 1, wherein the aliphatic urethane acrylate oligomer is present in an amount of 5.0%-40.0% based on the total mass of the UV curable hard-coat.

25. The UV curable hard-coat of claim 1, wherein the hexa-functional aliphatic urethane acrylate oligomer is present in an amount of 17.0%-68.0% based on the total mass of the UV curable hard-coat.

26.-28. (canceled)

29. The UV curable hard-coat of claim 1, wherein the organic solvent is 1,6-hexanediol di-acrylate and wherein the organic solvent is present in an amount of 8.0%-63.0% based on the total mass of the UV curable hard-coat.

30. (canceled)

31. The UV curable hard-coat of claim 1, which is resistant to cracking upon subjecting onto the UV curable hard-coat an outer fibre strain of a value selected from 1.5% to and including 4%, when the UV curable hard-coat is coated onto a polymerfilm such as a polycarbonate film, a polymethyl polymethacrylate (PMMA) film, a co-extruded film such as a co-extruded film comprising polycarbonate and/or PMMA, a multi-layer polymer film such as a composite comprising a layer of polycarbonate and/or comprising a layer of polyethylene terephthalate (PET), and subjected to the outer fibre strain by bending the coated polymer film, which is resistant to cracking due to elongation of the UV curable hard-coat with a value selected from 1% to and including 20%, preferably 2%-20%, more preferably 3%-20%, most preferably 4%-20%, such as 5%-18%, when the UV curable hard-coat is coated onto a polymer film such as a polycarbonate film, a PMMA film, a co-extruded film such as a co-extruded film comprising polycarbonate and/or PMMA, a multilayer polymer film such as a composite comprising a layer of polycarbonate and/or comprising a layer of PET, and subjected to the elongation by thermoforming of the coated polymer film.

32. (canceled)

33. A method for providing a hard-coated polymer film provided with the UV curable hard-coat of any one of the preceding claims, the method comprising the steps of:
a. providing a UV curable hard-coat according to claim 1;
b. providing a polymer film;
c. coating the polymer film of step b. with the UV curable hard-coat of step a.; and d. curing the coated polymer film of step c. with UV radiation,
therewith providing the hard-coated polymer film provided with the UV curable hard-coat of any one of the preceding claims.

34. The method of claim 33, wherein the polymer film of step b. is any one of a polycarbonate film, a PMMA film, a co-extruded film such as a co-extruded film comprising polycarbonate and/or comprising PMMA, a multi-layer polymer film such as a composite comprising a layer of polycarbonate and/or comprising a layer of PET.

35.-37. (canceled)

38. The method of claim 33, wherein the UV curable hard-coat of step a. is any one of the UV curable hard-coats which further comprise a flow modifier, wherein the flow modifier is poly-ether-modified polydimethylsiloxane or wherein the flow modifier is poly-ether-modified polydimethylsiloxane dissolved in xylene and iso-butanol at a 4(:)1 volume/volume ratio; and/or wherein in step b. the polymer film is polycarbonate film with a thickness of 0.20-0.30 mm, and/or wherein in step c. the coating is slot die coating, and/or wherein the curing of step d. is by irradiating the coated polymer film of step c. with a mercury vapor H-bulb UV irradiation source, such as a UV irradiation source; or wherein the UV curable hard-coat of step a. is any one of the UV curable hard-coats wherein the photo-initiator is bis(2,4,6-trimethylbenzoyl)-phenyl-phosphine oxide and the organic solvent is 1,6-hexanediol diacrylate, and/or wherein in step b. the polymer film is polycarbonate film with a thickness of 0.20-0.30, and/or wherein in step c. the coating is film coating, and/or wherein the curing of step d. is by irradiating the coated polymer film of step c. with a UV LED lamp irradiating UV light in the wavelength area 320 nm-400 nm.

39.-42. (canceled)

43. The method according to claim 33, wherein the polycarbonate film is heated at 50° C.-80° C., in a step d. after step c. and before step d; or wherein the polycarbonate film is heated at 50° C.-80° C. after step d.

44. (canceled)

45. A hard-coated polymer film provided with the UV curable hard-coat of claim 1 and obtained with the method steps of:
a. providing a UV curable hard-coat according to claim 1;
b. providing a polymer film;
c. coating the polymer film of step b. with the UV curable hard-coat of step a.; and d. curing the coated polymer film of step c. with UV radiation, therewith providing the hard-coated polymer film provided with the UV curable hard-coat of any one of the preceding claims; wherein the polymer film is any one of a polycarbonate film, a PMMA film, a coextruded film such as a co-extruded film comprising polycarbonate and/or comprising PMMA, preferably comprising polycarbonate and PMMA, a multi-layer polymer film such as a composite comprising a layer of polycarbonate and/or comprising a layer of PET, preferably both a layer of polycarbonate and a layer of PET, preferably a polycarbonate film.

46.-53. (canceled)

54. An article or object comprising a polymer film selected from any one of: a polycarbonate film, a PMMA film, a co-extruded film such as a co-extruded film comprising polycarbonate and/or comprising PMMA, a multi-layer polymer film such as a composite comprising a layer of polycarbonate and/or comprising a layer of PET, the polymer film containing a UV curable hard-coat according to claim 1, wherein the article or object is manufactured using moulding such as back moulding, back injection-moulding or in-mould electronics.

55. (canceled)
